(19) United States
(12) Patent Application Publication
(10) Pub. No.: US 2020/0193552 A1
(43) Pub. Date: Jun. 18, 2020

(54) SPARSE LEARNING FOR COMPUTER VISION

(71) Applicant: Slyce Acquisition Inc., Washington, DC (US)

(72) Inventors: Adam Turkelson, Washington, DC (US); Sethu Hareesh Kolluru, Washington, DC (US)

(21) Appl. No.: 16/719,697

(22) Filed: Dec. 18, 2019

Related U.S. Application Data
(60) Provisional application No. 62/781,422, filed on Dec. 18, 2018.

(51) Int. Cl. G06T 1/00; G06K 9/62; G06N 20/20; G06T 7/00

(52) U.S. Cl. CPC G06T 1/0014; G06K 9/6256; G06N 20/20; G06T 2207/20081; G06K 9/6228; G06T 7/0002; G06K 9/6232

(57) ABSTRACT

Provided is a process that includes training a computer-vision object recognition model with a training data set including images depicting objects, each image being labeled with an object identifier of the corresponding object; obtaining a new image; determining a similarity between the new image and an image from the training data set with the trained computer-vision object recognition model; and causing the object identifier of the object to be stored in association with the new image, visual features extracted from the new image, or both.

### CROSS-REFERENCE TO RELATED APPLICATIONS

This patent claims the benefit of U.S. Provisional Patent Application No. 62/781,422, filed on Dec. 18, 2018, and entitled “SPARSE LEARNING FOR COMPUTER VISION.” The entire content of each afore-listed, earlier-filed application is hereby incorporated by reference for all purposes.

### BACKGROUND

### 1. Field

The present disclosure relates generally to computer vision and, more specifically, to training computer vision models with sparse training sets.

### 2. Description of the Related Art

Moravec's paradox holds that many types of high-level reasoning require relatively few computational resources, while relatively low-level sensorimotor activities require relatively extensive computational resources. In many cases, the skills of a child are exceedingly difficult to implement with a computer, while the added abilities of an adult are relatively straightforward. A canonical example is that of computer vision, where it is relatively simple for a human to parse visual scenes and extract information, while computers struggle with this task.

Notwithstanding these challenges, computer vision algorithms have improved tremendously in recent years, particularly in the realm of object detection and localization within various types of images, such as two-dimensional images, depth images, stereoscopic images, and various forms of video. Variants include unsupervised and supervised computer vision algorithms, with the latter often drawing upon training sets in which objects in images are labeled. In many cases, trained computer-vision models ingest an image, detect an object from among an ontology of objects, and indicate a bounding area in pixel coordinates of the object along with a confidence score.

### SUMMARY

The following is a non-exhaustive listing of some aspects of the present techniques. These and other aspects are described in the following disclosure.

Some aspects include a process that includes: obtaining, with a computer system, a first training set to train a computer vision model, the first training set comprising images depicting objects and labels corresponding to object identifiers and indicating which object is depicted in respective labeled images; training, with the computer system, the computer vision model to detect the objects in other images based on the first training set, wherein the training the computer vision model comprises: encoding depictions of objects in the first training set as vectors in a vector space of lower dimensionality than at least some images in the first training set, and designating, based on the vectors, locations in the vector space as corresponding to object identifiers; detecting, with the computer system, a first object in a first query image by obtaining a first vector encoding a first depiction of the first object and selecting a first object identifier based on a first distance between the first vector and a first location in the vector space designated as corresponding to the first object identifier by the trained computer vision model; determining, with the computer system, based on the first distance between the first vector and the first location in the vector space, to include the first image or data based thereon in a second training set; and training, with the computer system, the computer vision model with the second training set.

Some aspects include a process that includes: obtaining a training data set including: a first image depicting a first object labeled with a first identifier of the first object, and a second image depicting a second object labeled with a second identifier of the second object; causing, based on the training data set, a computer-vision object recognition model to be trained to recognize the first object and the second object to obtain a trained computer-vision object recognition model, wherein: parameters of the trained computer-vision object recognition model encode first information about a first subset of visual features of the first object, and the first subset of visual features of the first object is determined based on one or more visual features extracted from the first image; obtaining, after training and deployment of the trained computer-vision object recognition model, a third image; determining, with the trained computer-vision object recognition mode, that the third image depicts the first object and, in response: causing the first identifier or a value corresponding to the first identifier to be stored in memory in association with the third image, one or more visual features extracted from the third image, or the third image and the one or more visual features extracted from the third image, determining, based on a similarity of the one or more visual features extracted from the first image and the one or more visual features extracted from the third image, that the third image is to be added to the training data set for retraining the trained computer-vision object recognition model, and enriching the parameters of the trained computer-vision object recognition model to encode second information about a second subset of visual features of the first object based on the one or more visual features extracted from the third image, wherein the second subset of visual features of the first object differs from the first subset of visual features of the first object.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example system for performing sparse learning for computer vision, in accordance with various embodiments;

FIG. 2 illustrates an example process for determining whether to a new image is to be added to a training data set for training a computer-vision object recognition model, in accordance with various embodiments;

FIG. 3 illustrates an example system for extracting features from images to be added to a training data set, in accordance with various embodiments;

FIGS. 4A-4C illustrate example graphs of feature vectors representing features extracted from images and determining a similarity between the feature vectors and a feature vector corresponding to a newly received image, in accordance with various embodiments;

FIG. 5 illustrates an example kiosk device for capturing images of objects and performing visual searches for those objects, in accordance with various embodiments; and

FIG. 6 illustrates an example of a computing system by which the present techniques may be implemented, in accordance with various embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer vision. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Existing computer-vision object detection and localization approaches often suffer from lower accuracy and are more computationally expensive than is desirable. In many cases, these challenges are compounded by use cases in which training sets are relatively small, while candidate objects in an ontology are relatively large. For example, a training data set may have less than 100 example images of each object, less than 10 example images of each object, or even a single image of each object. A computer-vision object recognition model trained with a training data set of these sizes may have a lower accuracy and scope, particularly when the candidate objects in an object ontology include more than 1,000 objects, more than 10,000 objects, more than 100,000 objects, or more than 1,000,000 objects, in some cases, ratios of any permutation of these numbers may characterize a relevant scenario. For example, a ratio of example images per object to objects in an ontology of less than 1/100; 1/1,000; 1/10,000; or 1/100,000 may characterize a scenario where an object recognition model trained with training data having one of the aforementioned ratios may produce poor results.

Some embodiments accommodate sparse training sets by implementing continual learning (or other forms of incremental learning) in a discriminative computer-vision model for object-detection. An example of a model for implementing incremental learning may include incremental support vector machine (SVM) models. Another example model may be a deep metric learning model, which may produce results including embeddings that have higher discriminative power than a regular deep learning model. For instance, clusters formed in an embedding space using the results of a deep metric learning model may be compact and well-separated. In some embodiments, feature vectors of an object the model is configured to detect are enriched at runtime. In some cases, after detecting the object in a novel image (e.g., outside of the model's previous training set), some embodiments enrich (or otherwise adjust) the feature vector of the object in the model with additional features of the object appearing in the new image, enrich parameters of the object recognition model, or both.

In some embodiments, a downstream layer of the model (e.g., a last or second to last layer) may produce an embedding for each image from the training data set and each newly received image. Each embedding may be mapped to an embedding space, which has a lower dimensionality than a number of pixels of the image. In some embodiments, a density of a cluster in the embedding space may be used to determine relationships between each embedding's corresponding image. In some embodiments, a clustering quality may be determined using a clustering metric, such as an F1 score, a Normalized Mutual Information (NMI) score, or the Mathews Correlation Coefficient (MCC). In some embodiments, embeddings for each image may be extracted using a pre-trained deep learning network. In some embodiments, the pre-trained deep learning network may include a deep neural network having a large number of layers. For example, the deep neural network may include six or more layers. A pre-trained deep learning network may include a number of stacked neural networks each of which includes several layers. As mentioned previously, the embeddings may refer to a higher dimension representation of a discrete variable where the number of dimensions is less than, for example, a number of pixels of an input image. Using the pre-trained deep learning network, an embedding may be extracted for each image. The embedding may be a representation of an object depicted by an image (e.g., a drill to be exactly matched). The embeddings may be generated using different models for aspects such as color, pattern, or other aspects. For example, a model may extract a color embedding that identifies a color of the object within an image, while another model may determine a pattern embedding identifying patterns within the image. In some embodiments, the embedding may be represented as a tensor. For example, an embedding tensor of rank 1 may refer to an embedding vector composed of an array of numbers (e.g., a 1 by N or N by 1 vector). The dimensionality of an embedding vector may vary depending on use case, for instance the embedding vector may be 32 numbers long, 64 numbers long, 128 numbers long, 256 numbers long, 1024 numbers long, 1792 numbers long, etc. The embeddings mapped to an embedding space may describe a relationship between two images. As an example, a video depicting a drill split into 20 frames may produce 20 vectors that are spatially close to one another in the embedding space because each frame depicts a same drill. An embedding space is specific to a model that generates the vectors for that embedding space. For example, a model that is trained to produce color embeddings would refer to a different embedding space that is unrelated to an embedding space produced by an object recognition model (e.g., each embedding space is independent form one another). In some embodiments, the spatial relationship between two (or more) embedding vectors in embedding space may provide details regarding a relationship of the corresponding images, particularly for use cases where a training data set includes a sparse amount of data.

Some embodiments perform visual searches using sparse data. Some embodiments determine whether to enrich a training data set with an image, features extracted from the image, or both, based on a similarity between the image and a previously analyzed image (e.g., an image from a training data set). Some embodiments determine whether an image previously classified as differing from the images including within a training data set may be added to the training data set based on a similarity measure computed with respect to the previously classified image and a newly received image.

To typically train a classifier, a large collection of examples are needed (e.g., 100-1000 examples per class). For example, ImageNet is an open source image repository that is commonly used to train object recognition models. The ImageNet repository includes more than 1 million images classified into 1,000 classes. However, when as little as one image is available to train an object recognition model, performing an accurate visual search can become challenging (which is not to suggest that the present techniques are not also useful for more data rich training sets or than any subject matter is disclaimed here or elsewhere herein).

In some embodiments, a plurality of images may be obtained where each image depicts a different object (e.g., a ball, a drill, a shirt, a human face, an animal, etc.). For example, a catalog of products may be obtained from a retailor or manufacturer and the catalog may include as few as one image depicting each product. The catalog of products may also include additional information associated with each product, such as an identifier used to label that product (e.g., a SKU for the product, a barcode for the product, a serial number of the product, etc.), attributes of the product (e.g., the product's material composition, color options, size, etc.), and the like. In some embodiments, a neural network or other object recognition model may be trained to produce a feature vector for each object depicted within one of the plurality of images. Depending on the number of features used, each object's image may represent one point in an n-dimensional vector space. In some embodiments, the object recognition model may output graph data indicating each object's location in the n-dimensional vector space. Generally, images that depict similar objects will be located proximate to one another in the n-dimensional vector space, whereas images that depict different objects will not be located near one another in the n-dimensional vector space.

In some embodiments, a user may submit an image of an item with the goal of a visual search system including an object recognition model identifying the corresponding object from the submitted image. The submitted photo may be run through the object recognition model to produce a feature vector for that image, and the feature vector may be mapped into the n-dimensional vector space. In some embodiments, a determination may be made as to which point or points in the n-dimensional vector space are “nearest” to the submitted feature vector's point. Using distance metrics to analyze similarity in feature vectors (e.g., Cosine distance, Euclidean distance, Manhattan distance, Minkowski distance, Mahalanobis distance), the feature vector closest to the submitted feature vector may be identified, and the object corresponding to that feature vector may be determined to be a “matching.” Some embodiments may include a user brining the object to a computing device configured to capture an image of the object, and provide an indication of any “matching” objects to the user. For example, the computing device may be part of or communicatively coupled to a kiosk including one or more sensors (e.g., a weight sensor, a temperature sensor, etc.) and one or more cameras. The user may use the kiosk for capturing the image, and the kiosk may provide information to the user regarding an identify (e.g., a product name, product description, location of the product in the store, etc.) of the object. In some embodiments, the submitted image, its corresponding feature vector, or both, may also be added to a database of images associated with that product. So, instead of the database only having one image of a particular object, upon the submitted image, its feature vector, or both, being added to the database, the database may now two images depicting that product—the original image and the submitted image.

In some embodiments, prior to adding the submitted image, its feature vector, or both, to the database, a determination may be made as to whether the image should be added. For instance, if the submitted image depicts the same object in a same manner (e.g., same perspective, same color, etc.), then inclusion of this image may not improve the accuracy of the object recognition model. For example, if the distance between the feature vector of the submitted image and the feature vector of an original image depicting the object stored in the database is less than a threshold distance (e.g., the cosine distance is approximately 1), then the submitted image, its feature vector, or both, may not provide any information gain, and in some cases, may not be added to the database.

In some embodiments, previously submitted images that were not identified as depicting a same or similar object as that of any of the images stored in the database may be re-analyzed based on the newly added image (e.g., the submitted image), its feature vector, or both. For example, a first image may have been determined to be dissimilar from any image included within a training data set of an object recognition model. However, after a newly submitted image is added to the training data set, such as in response to determining that the submitted. image “matches” another image included within the training data set, the newly added image may be compared to the first image. In some embodiments, a similarity measure (e.g., a distance in feature space) between the first image and the newly added image may be computed and, if the similarity satisfies a threshold similarity condition (e.g., the distance is less than a first threshold distance), the first image may be added to the training data set. Similarly, this process may iteratively scan previously obtained images to determine whether any are “similar” to the newly added image. In this way, the training data set may expand even without having to receive new images, but instead by obtaining a “bridge” image that bridges two otherwise “different” images.

Generally, the more images that are submitted for a training data set including images depicting a given object, the more accurate the object recognition model may become at identifying images that include the object. As an illustrative example, a catalog may include a single image of a particular model drill at a given pose (e.g., with at 0-degrees azimuth relative to some arbitrary plane in a coordinate system of the drill). In some embodiments, an object recognition model, such as a deep neural network, may produce a feature vector for the object based on the image. Some embodiments may receive an image of the same model drill (e.g., from another mobile computing device) at a later time, where this image depicts the drill at a different pose (e.g., with a 30-degree angle). The object recognition model may produce another feature vector for the object based on the newly submitted photo. Some embodiments may characterize the object based on both of feature vectors, which are expected to be relatively close in feature space (e.g., as measured by cosine distance, Minkowski distance, Euclidean distance, Mahalanobis distance, Manhattan distance, etc.) relative to feature vectors of other objects. Based on a proximity between the original feature vector and the submitted feature vector being less than a threshold distance (or more than a threshold distance from other feature vectors, or based on a cluster being determined with techniques like DB-SCAN), some embodiments may determine that the submitted photo depicts the same model drill (and in some cases, that it depicts the drill at a novel angel relative to previously obtained images). In response, some embodiments may: 1) add the new feature vector to a discriminative computer vision object recognition model with a label associating the added feature vector to the drill (resulting in multiple feature vectors having the same label of the drill), thereby enriching one or more parameters of the discriminative computer vision object recognition model; 2) modify an existing feature vector of the drill (e.g., representing the drill with a feature vector corresponding to a centroid of a cluster corresponding to the drill); or 3) add the image, the feature vector, or both the image and the feature vector, to a training data set with a label identifying the drill to be used in a subsequent training operation by which a computer vision object recognition model is updated or otherwise formed. Locations in vector space relative to which queries are compared may be volumes (like convex hulls of clusters) or points (like nearest neighbors among a training set's vectors).

In some embodiments, when a new image of the drill at yet another (e.g., novel relative to a training set) angle (e.g., 45-degrees) is received, a feature vector may be extracted from the image, and the resulting un-labeled feature vector may be matched to a closest labeled feature vector of the model (e.g., as determined with the above-noted distance measures). The new image may be designated as depicting the object labeled with the label born by the selected, closest feature vector of the model. In this way, a robust database of images and feature vectors for each item may be obtained.

In some embodiments, a popularity of an item or items (or co-occurrence rates of items in images) may be determined based on a frequency (or frequency and freshness over some threshold training duration, like more or less than a previous hour, day, week, month, or year) of searching or a frequency of use of a particular object classifier. For example, searches may form a time series for each object indicating fluctuations in popularity of each object (or changes in rates of co-occurrence in images). Embodiments may analyze these time series to determine various metrics related to the objects.

Some embodiments may implement unsupervised learning of novel objects absent from a training data set or extant ontology of labels. Some embodiments may cluster feature vectors, such as by using density-based clustering in the feature space. Some embodiments may determine whether clusters have less than a threshold amount (e.g., zero) labeled feature vectors. Such clusters may be classified as representing an object absent from the training data set or object ontology, and some embodiments may update the object ontology to include an identifier of the newly detected object. In some embodiments, the identifier may be an arbitrary value, such as a count, or it may be determined with techniques like applying a captioning model to extract text from the image, or by executing a reverse image lookup on an Internet image search engine and ranking text of resulting webpages by term-frequency inverse document frequency to infer a label from exogenous sources of information.

Some embodiments may enhance a training set for a visual search process that includes the following operations: 1) importing a batch of catalog product images, which may be passed to a deep neural network that extracts deep features for each image, which may be used to create and store an index; later, at run time, 2) receive a query image, pass the image to a deep neural network that extracts deep features, before computing distances to all images in the index and presenting a nearest neighbor as a search result. Some embodiments may receive a query image (e.g., a URL of a selected online image hosted on a website, a captured image from a mobile device camera, or a sketch drawn by a user in a bitmap editor) and determine the nearest neighbor, computing its distance in vector space.

Based on the distance (e.g., if the distance is less than 0.05 on a scale of 0-1), embodiments may designate the search was successful with a value indicating relatively high confidence, and embodiments may add the query image to the product catalog as ground truth to the index. If the distance is greater than certain threshold (e.g., 0.05 and less than say 0.2), embodiments may designate the result with a value indicating partial confidence and engage subsequent analysis, which may be higher latency operations run offline (i.e., not in real-time, for instance, taking longer than 5 seconds). For example, some embodiments may score the query image with each model in an ensemble of models (like an ensemble of deep convolutional neural networks) and based on a combined score (like an average or other measure of central tendency of the models) confirm that new object belongs to the same object as first network has predicted, before adding it to the index in response. The ensemble of models may operate offline, which may afford fewer or no constraints on latency, so different tradeoffs between speed and accuracy can be made.

In some embodiments, if the distance is greater than a threshold, embodiments may generate a task for humans (e.g., adding an entry and links to related data to a workflow management application), who may map the query to correct product, and embodiments may receive the mapping and update the index accordingly in memory. Or in some cases, the image may be determined to not correspond to the product or be of too low quality to warrant addition.

The machine learning techniques that can be used in the systems described herein may include, but are not limited to (which is not to suggest that any other list is limiting), any of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared. Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (IDA), Mixture Discriminant Analysis (MDA), Quadratic Discriminant Analysis (QDA), Flexible Discriminant Analysis (FDA), Ensemble Algorithms, Boosting, Bootstrapped. Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or separable convolutions (e.g., depth-separable convolutions, spatial separable convolutions)

In some embodiments, a feature extraction process may use deep learning processing to extract features from an image. For example, a deep convolution neural network (CNN), trained on a large set of training data (e.g., the AlexNet architecture, which includes 5 convolutional layers and 3 fully connected layers, trained using the ImageNet dataset) may be used to extract features from an image. In some embodiments, to perform feature extraction, a pre-trained machine learning model may be obtained, which may be used for performing feature extraction for images from a set of images. In some embodiments, a support vector machine (SVM) may be trained with a training data to obtain a trained model for performing feature extraction. In some embodiments, a classifier may be trained using extracted features from an earlier layer of the machine learning model. In some embodiments, preprocessing may be performed to an input image prior to the feature extraction being performed. For example, preprocessing may include resizing, normalizing, cropping, etc., to each image to allow that image to serve as an input to the pre-trained model. Example pre-trained networks may include AlexNet, GoogLeNet, MobileNet V1, MobileNet V2, MobileNet V3, and others. In some embodiments, the pre-trained networks may be optimized for client-side operations, such as MobileNet V2.

The preprocessing input images may be fed to the pre-trained model, which may extract features, and those features may then be used to train a classifier (e.g., SVM). In some embodiments, the input images, the features extracted from each of the input images, an identifier labeling each of the input image, or any other aspect capable of being used to describe each input image, or a combination thereof, may be stored in memory. In some embodiments, a feature vector describing visual features extracted from an image from the network, and may describe one or more contexts of the image and one or more objects determined to be depicted by the image. In some embodiments, the feature vector, the input image, or both, may be used as an input to a visual search system for performing a visual search to obtain information related to objects depicted within the image (e.g., products that a user may purchase).

In some embodiments, context classification models, object recognition models, or other models, may be generated using a neural network architecture that runs efficiently on mobile computing devices (e.g., smart phones, tablet computing devices, etc.). Some examples of such neural networks include, but are not limited to MobileNet V1, MobileNet V2, MobileNet V3, ResNet, NASNet, EfficientNet, and others. With these neural networks, convolutional layers may be replaced by depthwise separable convolutions. For example, the depthwise separable convolution block includes a depthwise convolution layer to filter an input, followed by a pointwise (e.g., 1×1) convolution layer that combines the filtered values to obtain new features. The result is similar to that of a conventional convolutional layer but faster. Generally, neural networks running on mobile computing devices include a stack or stacks of residual blocks. Each residual blocks may include an expansion layer, a filter layer, and a compression layer. With MobileNet V2, three convolutional layers are included: a 1×1 convolution layer, a 3×3 depthwise convolution layer, and another 1×1 convolution layer. The first 1×1 convolution layer may be referred to as the expansion layer and operates to expand the number of channels in the data prior to the depthwise convolution, and is tuned with an expansion factor that determines an extent of the expansion and thus the number of channels to be output. In some examples, the expansion factor may be six, however the particular value may vary depending on the system. The second 1×1 convolution layer, the compression layer, may reduce the number of channels, and thus the amount of data, through the network. In Mobile Net V2, the compression layer includes another 1×1 kernel. Additionally, with MobileNet V2, there is a residual connection to help gradients flow through the network and connects the input to the block to the output from the block. In some embodiments, the neural network or networks may be implemented using server-side programming architecture, such as Python, Keras, and the like, or they may be implanted using client-side programming architecture, such as TensorFlow Lite or TensorRT.

As described herein, the phrases “computer-vision object recognition model” and “object recognition computer-vision model” may be used interchangeably.

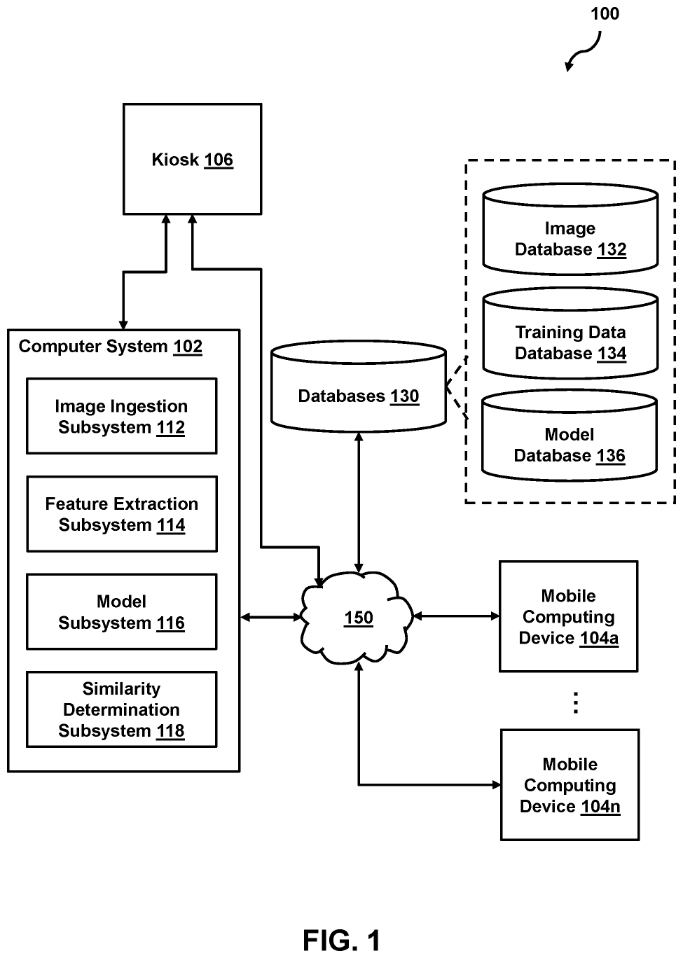

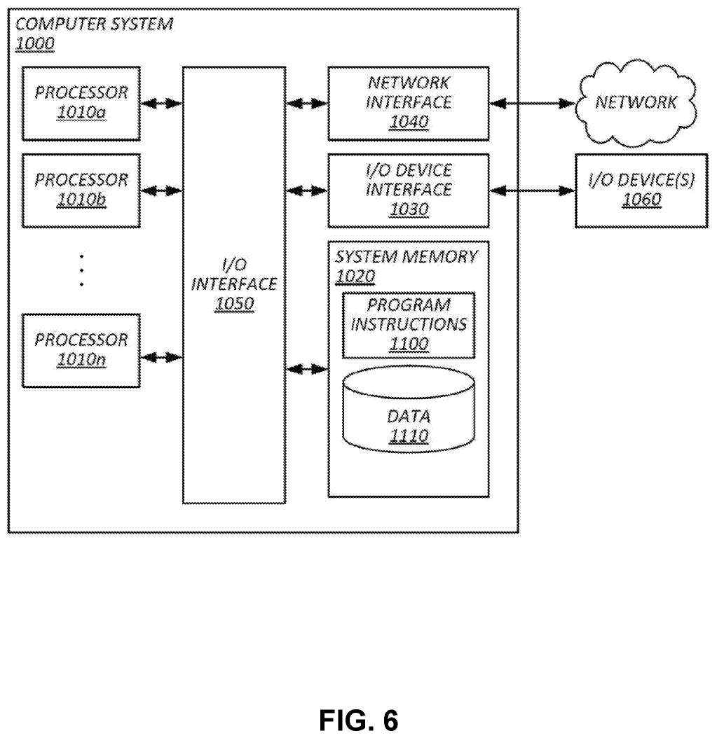

FIG. 1 illustrates an example system for performing sparse learning for computer vision, in accordance with various embodiments. System 100 of FIG. 1 may include a computer system 102, databases 130, mobile computing devices 104a-104n (which may be collectively referred to herein as mobile computing devices 104, or which may be individually referred to herein as mobile computing device 104), and other components. Each mobile computing device 104 may include an image capturing component, such as a camera, however some instances of mobile computing devices 104 may be communicatively coupled to an image capturing component. For example, a mobile computing device 104 may be wirelessly connected (e.g., via a Bluetooth connection) to a camera, and images captured by he camera may be viewable, stored, edited, shared, or a combination thereof, on mobile computing device 104. In some embodiments, each of computer system 102 and mobile computing devices 104 may be capable of communicating with one another, as well as databases 130, via one or more networks 150. Computer system 102 may include an image ingestion subsystem 112, a feature extraction subsystem 114, a model subsystem 116, a similarity determination subsystem 118, a training data subsystem 120, and other components. Databases 130 may include an image database 132, a training data database 134, a model database 136, and other databases. Each of databases 132-136 may be a single instance of a database or may include multiple databases, which may be co-located or distributed amongst a number of server systems. Some embodiments may include a kiosk 106 or other computing device coupled to computer system 102 or mobile computing device 104. For example, kiosk 106, which is described in greater detail below with reference to FIG. 6, may be configured to capture an image of an object may be connected to computer system 102 such that the kiosk may provide the captured image to computer system 102, which in turn may perform a visual search for the object and provide information related to an identity of the object to the kiosk.

In some embodiments, image ingestion subsystem 112 may be configured to obtain images depicting objects for generating or updating training data. For example, a catalog including a plurality of images may be obtained from a retailer, a manufacturer, or from another source, and each of the images may depict an object. The objects may include products (e.g., purchasable items), people (e.g., a book of human faces), animals, scenes (e.g., a beach, a body of water, a blue sky), or any other object, or a combination thereof. In some embodiments, the catalog may include a large number of images (e.g., 100 or more images, 1,000 or more images, 10,000 or more images), however the catalog may include a small number of images (e.g., fewer than 10 images, fewer than 5 images, a single image) depicting a given object. For example, a product catalog including images depicting a variety of products available for purchase at a retail store may include one or two images of each product (e.g., one image depicting a drill, two images depicting a suit, etc.). The small quantity of images of each object can prove challenging when training an object recognition model to recognize instances of those objects in a newly obtained image. Such a challenge may be further compounded by the large number of objects in a given object ontology (e.g., 1,000 or more objects, 10,000 or more objects, etc.).

In some embodiments, the images may be obtained from mobile computing device 104. For example, mobile computing device 104 may be operated by an individual associated with a retailer, and the individual may provide the images to computer system 102. via network 150. In some embodiments, the images may be obtained via an electronic communication (e.g., an email, an MMS message, etc.). In some embodiments, the images may be obtained by image ingestion subsystem 112 by accessing a uniform resource locator (URL) where the images may be downloaded to memory of computer system 102. In some embodiments, the images may be obtained by scanning a photograph of an object (e.g., from a paper product catalog), or by capturing a photograph of an object.

In some embodiments, each image that is obtained by image ingestion subsystem 112 may be stored in image database 132. Image database 132 may be configured to store the images organized by using various criteria. For example, the images may be organized within image database 132 with a batch identification number indicating the batch of images that were uploaded, temporally (e.g., with a timestamp indicating a time that an image was (i) obtained by computer system 102, (ii) captured by an image capturing device, (iii) provided to image database 132, and the like), geographically (e.g., with geographic metadata indicating a location of where the object was located), as well as based on labels assigned to each image which indicate an identifier for an object depicted within the image. For instance, the images may include a label of an identifier of the object (e.g., a shoe, a hammer, a bike, etc.), as well as additional object descriptors, such as, and without limitation, an object type, an object subtype, colors included within the image, patterns of the object, and the like.

In some embodiments, image ingestion subsystem 112 may be configured to obtain an image to be used for performing a visual search. For example, a user may capture an image of an object that the user wants to know more information about. In some embodiments, the image may be captured via mobile computing device 104, and the user may send the image to computer system 102 to perform a visual search for the object. In response, computer system 102 may attempt to recognize the object depicted in the image using a trained object recognition model, retrieve information regarding the recognized object (e.g., a name of the object, material composition of the object, a location of where the object may be purchased, etc.), and the retrieved information may be provided back to the user via mobile computing device 104. In some embodiments, an individual may take a physical object to a facility where kiosk 106 is located. The individual may use kiosk 106 (e.g., via one or more sensors, cameras, and other components of kiosk 106) to analyze the object, capture an image of the object. In some embodiments, kiosk 106 may include some or all of the functionality of computer system 102, or of a visual search system, and upon capturing an image depicting the object, may perform a visual search to identify the object and retrieve information regarding the identified object. Alternatively, or additionally, kiosk 106 may provide the captured image of the object, as well as any data output by the sensors of kiosk 106 (e.g., a weight sensor, dimensionality sensor, temperature sensor, etc.), to computer system 102 (either directly or via network 150). In response to obtaining the captured image, image ingestion subsystem 112 may facilitate the performance of a visual search to identify the object depicted by the captured image, retrieve information related to the identified image, and provide the retrieved information to kiosk 106 for presentation to the individual.

In some embodiments, feature extraction subsystem 114 may be configured to extract features from each image obtained by computer system 102. The process of extracting features from an image represents a technique for reducing the dimensionality of an image, which may allow for simplified and expedited processing of the image, such as in the case of object recognition. An example of this concept is an N×M pixel red-blue-green (RBG) image being reduced from N×M×3 features to N×M features using a mean pixel value process of each pixel in the image from all three-color channels. Another example feature extraction process is edge feature detection. In some embodiments, a Prewitt kernel or a Sobel kernel may be applied to an image to extract edge features. In some embodiments, edge features may be extracted using feature descriptors, such as a histogram of oriented gradients (HOG) descriptor, a scale invariant feature transform (SIFT) descriptor, or a speeded-up robust feature (SURF) description.

In some embodiments, feature extraction subsystem 114 may use deep learning processing to extract features from an image, whether the image is from a plurality of images initially provided to computer system 10 (e.g., a product catalog), or a newly received image (e.g., an image of an object captured by kiosk 106). For example, a deep convolution neural network (CNN), trained on a large set of training data (e.g., the AlexNet architecture, which includes 5 convolution layers and 3 fully connected layers, trained using the ImageNet dataset) may be used to extract features from an image. Feature extraction subsystem 114 may obtain a pre-trained machine learning model from model database 136, which may be used for performing feature extraction for images from a set of images provided to computer system 102. (e.g., a product catalog including images depicting products). In some embodiments, a support vector machine (SVM) may be trained with a training data to obtain a trained model for performing feature extraction. In some embodiments, a classifier may be trained using extracted features from an earlier layer of the machine learning model. In some embodiments, feature extraction subsystem 114 may perform preprocessing to the input images. For example, preprocessing may include resizing, normalizing, cropping, etc., to each image to allow that image to serve as an input to the pre-trained model. Example pre-trained networks may include AlexNet, GoogLeNet, MobileNet-v2, and others. The preprocessing input images may be fed to the pre-trained model, which may extract features, and those features may then be used to train a classifier (e.g., SVM). In some embodiments, the input images, the features extracted from each of the input images, an identifier labeling each of the input image, or any other aspect capable of being used to describe each input image, or a combination thereof, may be stored in training data database 134 as a training data set used to train a computer-vision object recognition model.

In some embodiments, model subsystem 116 may be configured to obtain a training data set from training data database 134 and obtain a computer-vision object recognition model from model database 136. Model subsystem 116 may further be configured to cause the computer-vision object recognition model to be trained based on the training data set. An object recognition model may describe a model that is capable of performing, amongst other tasks, the tasks of image classification and object detection. Image classification relates to a task whereby an algorithm determines an object class of any object present in an image, whereas object detection relates to a task whereby an algorithm that detect a location of each object present in an image. In some embodiments, the task of image classification takes an input image depicting an object and outputs a label or value corresponding to the label. In some embodiments, the task of object localization locates the presence of an object in an image (or objects if more than one are depicted within an image) based on an input image, and outputs a bounding box surrounding the object(s). In some embodiments, object recognition may combine the aforementioned tasks such that, for an input image depicting an object, a bounding box surrounding the object and a class of the object are output. Additional tasks that may be performed by the object recognition model may include object segmentation, where pixels represented a detected object are indicated.

In some embodiments, the object recognition model may be a deep learning model, such as, and without limitation, a convolutional neural network (CNN), a region-based CNN (R-CNN), a Fast R-CNN, a Masked R-CNN, Single Shot Multibox (SSD), and a You-Only-Look-Once (YOLO) model (lists, such as this one, should not be read to require items in the list be non-overlapping, as members may include a genus or species thereof, for instance, a R-CNN is a species of CNN and a list like this one should not be read to suggest otherwise). As an example, an R-CNN may take each input image, extract region proposals, and compute features for each proposed region using a CNN. The features of each region may then be classified using a class-specific SVM, identifying the location of any objects within an image, as well as classifying those images to a class of objects.

The training data set may be provided to the object recognition model, and model subsystem 116 may facilitate the training of the object recognition model using the training data set. In some embodiments, model subsystem 116 may directly facilitate the training of the object recognition model (e.g., model subsystem 116 trains the object recognition model), however alternatively, model subsystem 116 may provide the training data set and the object recognition model to another computing system that may train the object recognition model. The result may be a trained computer-vision object recognition model, which may be stored in model database 136.

In some embodiments, parameters of the object recognition model, upon the object recognition model being trained, may encode information about a subset of visual features of each of object from the images included by the training data set. Furthermore, the subset of visual features may be determined based on visual features extracted from each image of the training data set. In some embodiments, the parameters of the object recognition model may include weights and biases, which are optimized by the training process such that a cost function measuring how accurately a mapping function learns to map an input vector to an expected outcome is minimized. The number of parameters of the object recognition model may include 100 or more parameters, 10,000 or more parameters, 100,000 or more parameters, or 1,000,000 or more parameters, and the number of parameters may depend on a number of layers the model includes. In some embodiments, the values of each parameter may indicate an effect on the learning process that each visual feature of the subset of visual features has. For example, the weight of a node of the neural network may be determined based on the features used to train the neural network, therefore the weight encodes information about the parameter because the weight's value is obtained as a result of its optimization from the subset of visual features.

In some embodiments, model subsystem 116 may be further configured to obtain the trained computer-vision object recognition model from model database 136 for use by feature extraction subsystem 114 to extract features from a newly received image. For example, a newly obtained image, such as an image of an item captured by kiosk 106 and provided to computer system 102, may be analyzed by feature extraction subsystem 114 to obtain features describing the image, and any object depicted by the image. Feature extraction subsystem 114 may request the trained object recognition model from model subsystem 116, and feature extraction subsystem 114 may use the trained object recognition model to obtain features describing the image. In some embodiments, model subsystem 116 may deploy the trained computer-vision object recognition model such that, upon receipt of a new image, the trained computer-vision object recognition model may be used to extract features of the object and determine what object or objects, if any, are depicted by the new image. For example, the trained computer-vision object recognition model may be deployed to kiosk 106, which may use the model to extract features of an image captured thereby, and provide those features to a visual search system (e.g., locally executed by kiosk 106, a computing device connected to kiosk 106, or a remote server system) for performing a visual search.

In some embodiments, similarity determination subsystem 118 may be configured to determine whether an object (or objects) depicted within an image is similar to an object depicted by another image used to train the object recognition model. For example, similarity determination subsystem 118 may determine, for each image of the training data set, a similarity measure between the newly obtained image and a corresponding image from the training data set. Similarity determination subsystem 118 may determine a similarity between images, which may indicate whether the images depict a same or similar object. In some embodiments, the similarity may be determined based on one or more visual features extracted from the images. For example, a determination of how similar a newly received image is with respect to an image from a training data set may be determined by determining a similarity of one or more visual features extracted from the newly received image and one or more visual features extracted from the image from the training data set.

In some embodiments, to determine the similarity between the visual features of two (or more) images, a distance between the visual features of those images may be computed. For example, the distance computed may be a cosine distance, a Minkowski distance, a Euclidean distance, a Hamming distance, a Manhattan distance, a Mahalanobis distance, or any other vector space distance measure, or a combination thereof. In some embodiments, if the distance is less than or equal to a threshold distance value, then the images may be classified as being similar. For example, two images may be classified as depicting a same object if the distance between those images' feature vectors (e.g., determined by computing a dot product of the feature vectors) is approximately zero (e.g., Cos(θ)˜1). In some embodiments, the threshold distance value may be predetermined. For example, a threshold distance value that is very large (e.g., where θ is the angle between the feature vectors, Cos(θ)>0.6) may produce a larger number of “matching” images. As another example, a threshold distance value that is smaller (e.g., Cos(θ)>0.95) may produce a small number of “matching” images.

In some embodiments, similarity determination subsystem 118 may be configured to determine based on a similarity between images (e.g., visual features extracted from the features), whether that image should be labeled with an object identifier of the matching image. As an example, a distance between visual features extracted from a newly received image, such as an image obtained from kiosk 106, and visual feature extracted from an image from a training data set may be determined. If the distance is less than a threshold distance value, this may indicate that the newly received image depicts a same or similar object as the image from the training data set. In some embodiments, the newly received image may be stored in memory with an identifier, or a value corresponding to the identifier, used to label the image from the training data store. In some embodiments, the newly received image may also be added to the training data set such that, when the previously trained object recognition model is re-trained, the training data set will include the previous image depicting the object and the newly received image, which also depicts the object. This may be particularly useful in some embodiments where a small number of images for each object are included in the initial training data set. For example, if a training data set only includes a single image depicting a hammer, a new image that also depicts a same or similar hammer may then be added to the training data set for improving the object recognition model's ability to recognize a presence of a hammer within subsequently received images. In some embodiments, the threshold distance value or other similarity threshold values may be set with an initial value, and an updated or threshold value may be determined over time. For example, an initial threshold distance value may be too low or too high, and similarity determination subsystem 118 may be configured to adjust the threshold similarity value (e.g., threshold distance value) based on the accuracy of the model.

Some embodiments may include enriching, or causing to be enriched, the parameters of the trained computer-vision object recognition model to encode second information about a second subset of visual features of the first object based on the features extracted from the newly received image. For instance, the newly received image and the image may depict the same or similar object, as determined based on the similarity between the features extracted from these images. However, the newly received image may depict some additional or different characteristics of the object that are not present in the image previously analyzed. For example, the first image may depict a drill from a 0-degrees azimuth relative to some arbitrary plane in a coordinate system of the drill, whereas the newly received image may depict the drill from a 45-degree angle, which may reveal some different characteristics of the drill not previously viewable. Thus, the second information regarding these new characteristics may be used to enrich some or all of the parameters of the object recognition model to improve the object recognition model's ability to recognize instances of that object (e.g., a drill) in subsequently received images, in some embodiments, enriching parameters of the computer-vision object recognition model may include re-training the object recognition model using an updated training data set including the initial image (or the subset of visual features extracted from the initial image) and the newly received image (or the subset of visual features extracted from the newly received image). In some embodiments, enriching the parameters may include training a new instance of an object recognition model using a training data set including the initial image (or the subset of visual features extracted from the initial image) and the newly received image (or the subset of visual features extracted from the newly received image). In some embodiments, the parameters being enriched may include adjusting the parameters. For example, the weights and biases of the object recognition model may be adjusted based on changes to an optimization of a loss function for the model as a result of the newly added subset of features.

In some embodiments, similarity determination subsystem 118 may be configured to determine whether a newly received image is too similar to an image already included within a training data set. For instance, a determination may be made as to whether inclusion of the newly received image will improve the accuracy of the object recognition model if added to the training data set. If not, then the newly received image may not be added to the training data set. However, even in such cases, the object identifier for the matching image may be stored in memory in association with the new image. Alternatively, the newly received image may not be stored in association with the object identifier, or value corresponding to the object identifier. In such cases, the newly received image may be stored in image database 132, temporally or indefinitely, or may be discarded.

In some embodiments, similarity determination subsystem 118 may determine, subsequent to storing a new image, visual features extracted from the new image, or both, in association with an object identifier or value corresponding to the object identifier, whether any previously analyzed images are similar to the new image, visual features, or both. For instance, prior to an image being received, another image may have been analyzed and determined to be not similar to any image stored in memory. As an example, a first image depicting a first object, either originally from the training data set or obtained by computer system 102 from kiosk 106 or mobile computing device 104, may have been determined to be dissimilar to a second image depicting a second object included within the training data set (e.g., a distance between a feature vector representing visual features extracted from the first image and a feature vector representing visual features extracted from the second image is greater than a first threshold value). In some embodiments, a newly received third image may be determined as being similar to the first image (e.g., a distance between a feature vector representing visual features extracted from the third image is less than the first threshold value). Upon storing the third image in memory in association with an object identifier or value corresponding to the object depicted in the first image, similarity determination subsystem 118 may determine a similarity between the third image and the second image. If the third image and the second image are determined to be similar, then the second image—which previously was determined as being dissimilar to the first image may also be stored in memory with the object identifier or value corresponding to the object identifier of the object depicted in the first image. Thus, the newly received third image may serve as a bridge to recapture images depicting objects that may have initially be viewed as dissimilar from the images from the training data set. As an example, an image depicting a hammer and an image depicting a fastener may initially have been classified as being dissimilar. However, a new image depicting a hammer and a fastener may be classified as being similar to the image depicting the hammer, and subsequently, the image depicting the fastener may be classified as being similar to the image depicting the hammer and the fastener. Therefore, the image depicting the fastener may be classified as being similar to the image depicting the hammer based on the bridge image depicting the hammer and the fastener.

In some embodiments, the process of recapturing images may be iteratively performed until one or more stopping criteria are met. For example, after each new image is analyzed, all of the stored images may be compared to the new image to determine if the new image is similar to any other images. If so, the new image may be assigned the object identifier of the similar image, as well as, or alternatively, added to a training data set including the similar image. The same steps may be repeated for all images not assigned to a given object identifier or not assigned to any object identifiers (e.g., but stored in image database 132), to determine if those images are similar to the newly identified similar images. Such steps may loop iteratively for a predetermined number of times (e.g., one or more iterations, five or more iterations, etc.), for a predetermined amount of time (e.g., 1 second, 2 seconds, 5 seconds, 10 seconds, etc.), until no more “similar” images are identified, or a combination thereof.

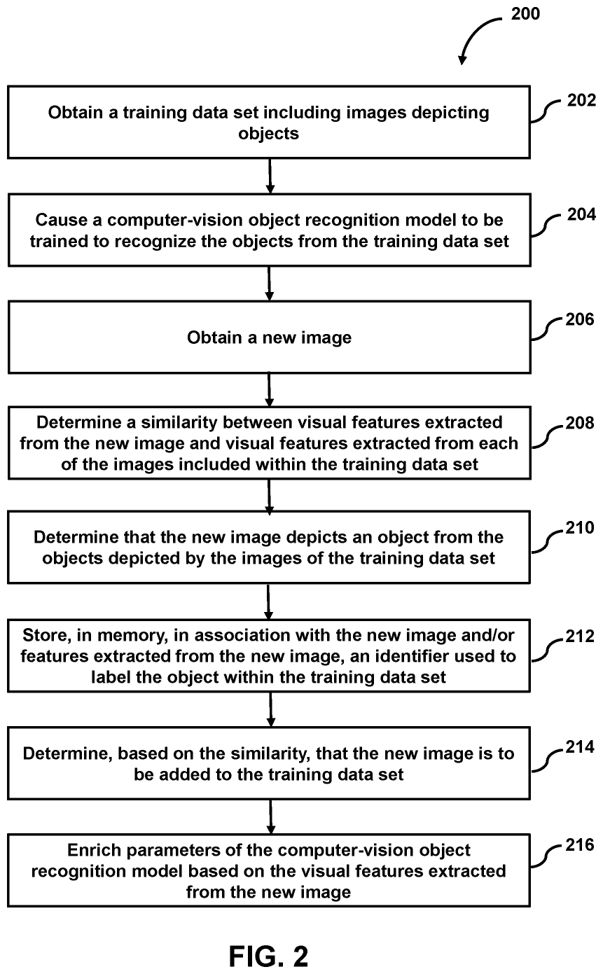

FIG. 2 illustrates an example process for determining whether to a new image is to be added to a training data set for training a computer-vision object recognition model, in accordance with various embodiments. In some embodiments, process 200 may begin at step 202. At step 202, a training data set including images depicting objects may be obtained. In some embodiments, the training data set may include a plurality of images (e.g., 1,000 or more images, 10,000 or more images, 100,000 or more images, 1,000,000 or more images, etc.). Each image may depict an object from an object ontology including a plurality of objects (e.g., 100 or more objects, 1,000 or more objects, 10,000 or more objects, etc.). Some embodiments include an object being depicted by a sparse number of images, such as five or fewer images, 2 or fewer images, or even by only a single image. For example, of the plurality of images obtained, only one image may depict a drill, only one image may depict a fastener, only one image may depict a table, and so on. In some embodiments, the training data set may be generated based on a set of images obtained from an entity, such as a retailer, a manufacturer, a human, etc. For example, the set of images may be analyzed using a pre-trained object recognition model (e.g., AlexNet, GoogLeNet, MobileNet v2, etc.), features may be extracted from each image, and the training data set may be generated based on some or all of the images of the set of images, some or all of the features extracted from the images, or both. The training data set may be stored in training data database 134, while the set of images may be stored in image database 132. In some cases, the set of images may be stored in image database 132 for indefinitely, or for a predetermined amount of time (e.g., one day, one week, one month, one year, etc.). In some embodiments, step 202 may be performed by a subsystem that is the same or similar to image ingestion subsystem 112.

At step 204, a computer-vision object recognition model may be trained, or caused to be trained, so as to recognize the objects from the training data set. The computer-vision object recognition model may differ from the pre-trained object recognition model described above for generation of the training data set. In some embodiments, the computer-vision object recognition model may be generated to specifically recognize the objects depicted by the images within the training data set. For example, a propriety visual search system may be train an object recognition model to recognize a particular set of objects within input images (e.g., an object recognition model trained to recognize hardware tools in images, an object recognition model trained to recognize furniture in images, a facial recognition model trained to recognize human faces in images, etc.). In some embodiments, the computer-vision object recognition model may be a deep learning network including a plurality of layers, such as a plurality of convolutional layers, a plurality of pooling layers, one or more SoftMax layers, and the like. Some embodiments may include obtaining the (to-be-trained) computer-vision object recognition model from model database 136, and providing the training data set to the computer-vision object recognition model for training. However, as mentioned above, if the training data set includes a sparse number of images depicting a particular object, the computer-vision object recognition model may have difficultly recognizing instances of the object in subsequently analyzed images unless those images depict the object in a very similar manner. As a result, the overall breadth and accuracy of the object recognition model may suffer due to the limited robustness of the training data set.

Some embodiments may include the trained computer-vision object recognition model having parameters that encode information about a subset of visual features of the object depicted by each image from the training data set. For example, by training the computer-vision object recognition using the training data set, weights and biases of neuron of a neural network (e.g., a convolutional neural network, a deep metric learning network, a region-based convolution neural network, a deep neural network, etc.) may be adjusted. The adjustment of the weights and biases, thus the configurations of the parameters of the object recognition model, enable the object recognition model to recognize objects within input images. For example, for a given input feature vector, generated from features extracted from an image, the model is able to identify an identifier of the object depicted by an image, where the identifier corresponds to one of the identifiers of the objects from the training data set, and a location of the object within the image. Furthermore, the subset of visual features of each object, with which the parameters are encoded with information about, is determined—for each object—based on the extracted visual features from a corresponding image depicting that object. For example, the subset of visual features may include localized gradients for edge detection of each image, a mean pixel value for a multichannel color image, and the like. In some embodiments, step 204 may be performed by a subsystem that is the same or similar to model subsystem 116.

At step 206, a new image may be obtained. In some embodiments, the new image may be obtained from kiosk 106. For example, an individual seeking to identify an object, or obtain more information regarding an object, or both, may use kiosk 106 to capture an image of the object. Kiosk 106 may provide the captured image to computer system 102 for performing a visual search, or kiosk 106 may perform the visual search using a computing system integrated into or communicatively coupled or co-located with kiosk 106. As another example, an individual may capture an image of an object using mobile computing device 104, and may perform a visual search using mobile computing device 104 or may provide the captured image to computer system 102 (or a different computing system) for performing the visual search. In some embodiments, after the object recognition model has been trained and deployed to a visual search system, where the visual search system may reside on computer system 102, mobile computing device 104, kiosk 106, another computing system, or a combination thereof, the new image may be obtained. In some embodiments, step 206 may be performed by a subsystem that is the same or similar to image ingestion subsystem 112.

At step 208, a similarity between visual features extracted from the new image and visual features extracted from each of the images included within the training data set may be determined. In some embodiments, visual features may be extracted from the new image. For example, the trained computer-vision object recognition model may extract one or more visual features describing the new image. The visual features may be compared to the visual features extracted from each of the images from the training data set to determine a similarity between the visual features of the new image and the visual features of the images from the training data set. In some embodiments, the visual features of the new image and the visual features of the images from the training data set may be represented as feature vectors in an n-dimensional feature space.

In some embodiments, a similarity between two images may be determined by computing a distance in the n-dimensional feature space between the feature vector representing the new image and a feature vector of a corresponding image from the training data set. For example, the distance computed may include a cosine distance, a Minkowski distance, a Euclidean distance, or other metric by which similarity may be computed. In some embodiments, step 208 may be performed by a subsystem that is the same or similar to similarity determination subsystem 118.

At step 210, a determination may be made that the new image depicts an object from the objects depicted by the images of the training data set. In some embodiments, the distance between two feature vectors (e.g., a feature vector describing the new image and a feature vector describing one of the images from the training data set) may be compared to a threshold distance. If the distance is less than or equal to the threshold distance, then the two images may be classified as being similar, classified as depicting a same or similar object, or both. For example, if a cosine of an angle between the two vectors produces a value that is approximately equal to 1 (e.g., Cos(θ)≥0.75, Cos(θ)≥0.8, Cos(θ)≥0.85, Cos(θ)≥0.9, Cos(θ)≥0.95, Cos(θ)≥0.99, etc.), then the two feature vectors may describe similar visual features, and therefore the objects depicted within the images with which the features were extracted from may be classified as being similar. In some embodiments, step 210 may be performed by a subsystem that is the same or similar to similarity determination subsystem 118.

At step 212, an identifier used to label the object within the training data set may be stored in memory in association with the new image, the features extracted from the new image, or both the new image and the features extracted from the new image. In some embodiments, each image from the training data set may be labeled with an identifier of the object depicted by that image. Upon determining that a new image depicts a same object as an image from the training data set, the identifier of the object depicted by that image may be stored in association with the new image. For example, if a new image is determined to depict a drill matching a drill depicted by a first image from a training data set, and the first image is labeled with a first identifier depicting the drill, then the new image may be assigned the first identifier. In some embodiments, the first identifier may be stored in image database 132, training data database 134, or both image database 132 and training data database 134 with the new image. In some embodiment, a value corresponding to the first identifier may be stored in association with the new image instead of, or in addition to, the first identifier, instance, an object identifier array may include n-dimensions (e.g., ID_vec={v₁, v₂, . . . , vₙ}, where each element represents one object identifier of the object identifiers used to label the objects depicted in the training data set's images. As an example, if the object identifier for a drill corresponds to the 86^{th} identifier, then an image depicting a drill would have an ID vector with all elements equal to 0 except for v₈₅, which would have a value 1. Therefore, with this example, a new image determined to depict the drill may also have the value 1 for element v₈₅ of the ID vector.

In some embodiments, the identifier or value corresponding to the identifier may be stored in memory in association with the new image in response to a determination that the new image depicts a same object as an image from the training data set. For example, the assignment and storage of the identifier or value may occur automatically and immediately in real-time after the determination that the new image depicts the same object. As another example, the assignment and storage of the identifier or value may occur at a later time (e.g., one or more seconds after the determination, one or more minutes after the determination, one or more days after the determination, one or more weeks after the determination, one or more months after the determination, etc.). In some embodiments, step 212 may be performed by a subsystem that is the same or similar to similarity determination subsystem 118.

At step 214, a determination may be made that the new image is to be added to the training data set based on the similarity. For instance, because the new image was determined to be similar to another image from the training data set, depict a similar object as an image from the training data set, or both, the new image may be used for subsequent training of the object recognition model. In some embodiments, a determination may be made as to whether the new image is the image from the training data set are too similar. For example, and as mentioned above, a determination may be made that a distance between a feature vector describing the new image and a feature vector describing the image from the training set is less than a first threshold distance value (e.g., Cos(θ)≥0.75, Cos(θ)≥0.8, Cos(θ)≥0.85, Cos(θ)≥0.9, Cos(θ)≥0.95, Cos(θ)≥0.99, etc.), indicating that the two images include similar features. However, if the two images are too similar, such as if the images are identical to one another, then there may be little value in adding that image to the training data set because the object recognition model will likely not learn much, if any, new information. Therefore, a determination may be made as to whether the feature vector describing the new image and the feature vector describing the image from the training set is greater than or equal to a second threshold distance value (e.g., Cos(θ)≤0.99, Cos(θ)≤0.95, Cos(θ)≤0.9, Cos(θ)≤0.85, etc.). If so, then this may indicate that the two images include similar features, but are different enough that the new image may be added to the training set for re-training the object recognition model. In some embodiments, step 214 may be performed by a subsystem that is the same or similar to similarity determination subsystem 118.

At step 216, parameters of the computer-vision object recognition model may be enriched based on the visual features extracted from the new image. In some embodiments, the parameters of the trained computer-vision object recognition model may be enriched such that the parameters encode information about a subset of visual features of the object from the training data set that was identified as being similar to the new image. For instance, visual features extracted from the new image may be used to adjust weights and biases of the object recognition model. In some embodiments, the features extracted from the new image may be included in an updated feature vector describing the image from the training data set that was determined to be similar to the new image. For example, a subset of visual features extracted from the new image may be added to the feature vector of the matching image from the training data set, the subset of visual features may be used to adjust or update a subset of features from the feature vector, or a combination thereof. In some embodiments, the subset of visual features of the object extracted from the new image may differ from a subset of visual features of the object extracted from the matching image. In some embodiments, the information regarding these new characteristics may be used to enrich some or all of the parameters of the object recognition model to improve the object recognition model's ability to recognize instances of that object (e.g., a drill) in subsequently received images. In some embodiments, enriching parameters of the computer-vision object recognition model may include re-training the object recognition model using an updated training data set including the initial image (or the subset of visual features extracted from the initial image) and the newly received image (or the subset of visual features extracted from the newly received image). In some embodiments, enriching the parameters may include training a new instance of an object recognition model using a training data set including the initial image (or the subset of visual features extracted from the initial image) and the newly received image (or the subset of visual features extracted from the newly received image). In some embodiments, step 216 may be performed by a subsystem that is the same or similar to model subsystem 116.

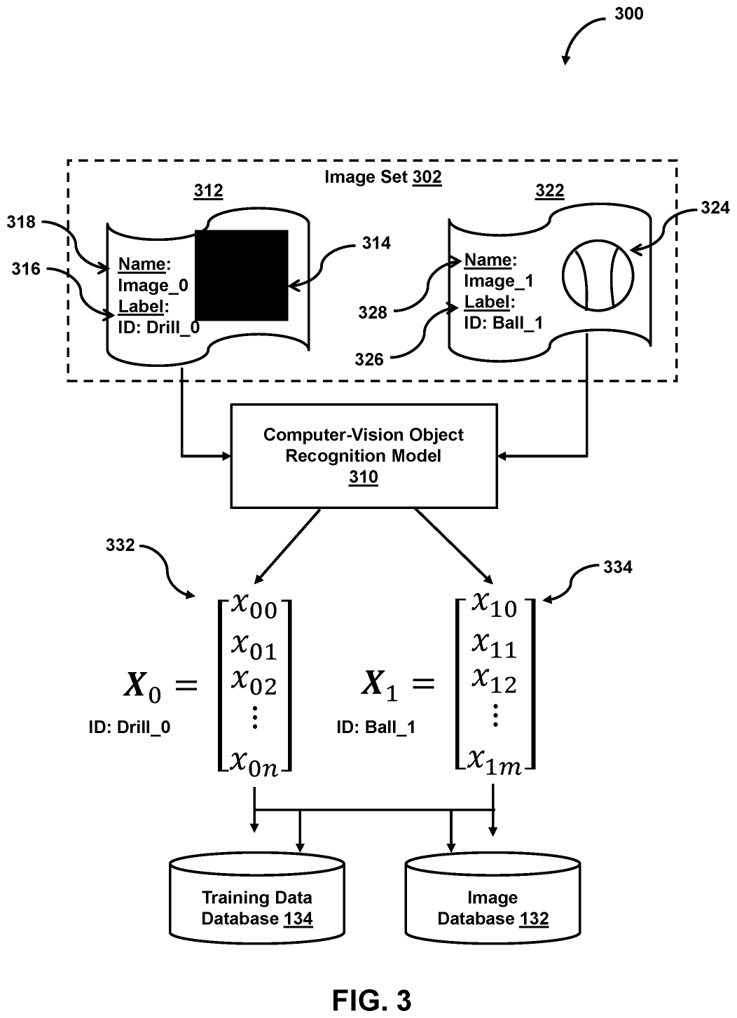

FIG. 3 illustrates an example system for extracting features from images to be added to a training data set, in accordance with various embodiments. In some embodiments, system 300 may include an image set 302, which may be obtained from image database 132, training data database 134, computer system 102, or another database, or another computing system. In some embodiments, image set 302 may be part or all of a set of input images obtained by image ingestion subsystem 112. For example, image set 302 may be a portion of a product catalog provided by a retailer to computer system 102.

In some embodiments, image set 302 may include a plurality of images each depicting at least one object, as well as additional information regarding each of the objects. For instance, image set 302 may include first image data 312 and second image data 322. In some embodiments, the number of images included within image set 302 may be large, such as 1,000 or more images, 10,000 or more images, 100,000 or more images, 1,000,000 or more images, etc. However, while the number of images may be large, the number of images depicting a same or similar object may be small. For example, image set 302 may include only a single image of a given object. Thus, while image set 302 may be robust, it may also be sparse. Some embodiments describe first image data 312 including a first image 314 depicting a first object (e.g., a drill), a first object identifier 316 used to label the object (e.g., “ID: Drill_0”), and an image name 318 (e.g., “Image_0”). Some embodiments describe second image data 322 including a second image 324 depicting a second object (e.g., a baseball), a second object identifier 326 used to label the object (e.g., ID: Ball_1”), and an image name 328 (e.g., “Image_1”). In some embodiments, image set 302 may include only first image data 312 including first image 314 depicting the first object, and only second image data 322 including second image 324 depicting the second object.

In some embodiments, image set 302 may be provided to a computer-vision object recognition model 310, which may be configured to analyze first image 314 and second image 324 and output a first feature vector 332 and a second feature vector 334, respectively. For example, first feature vector 332 may be an n-dimensional feature vector xo including n elements that describe n visual features of first image 314. Similarly, second feature vector 334 may be an in-dimensional feature vector x₁ including m elements that describe in visual features of first image 324. In some embodiments, n may equal m, however the values may, alternatively, differ.

In some embodiments, computer-vision object recognition model 310 may be a pre-trained object recognition model stored within model database 136. For example, the images from image set 302 may be analyzed using a pre-trained object recognition model (e.g., AlexNet, GoogLeNet, MobileNet v2, etc.), and features may be extracted from each image. In some embodiments, a support vector machine (SVM) may be trained with to obtain a trained model for performing feature extraction. In some embodiments, a classifier may be trained using extracted features from an earlier layer of the machine learning model.

After providing images 314 and 324 to computer-vision object recognition model 310, feature vectors 332 and 334 may be obtained. Furthermore, providing images 314 and 324 to computer-vision object recognition model 310 may cause computer-vision object recognition model 310 to be trained to recognize objects within images. A trained instance of computer-vision object recognition model 310 may be stored in model database 136, and upon receipt of a new image to be analyzed, the trained computer-vision object recognition model may be retrieved and used to classify and locate objects that may be depicted within the new image. In some embodiments, each of feature vectors 332 and 334 may be formed based on a subset of visual features extracted from each image. For example, the visual features may include color descriptors, shape descriptors, texture descriptors, edge descriptors, and the like. Feature vectors 332 and 334 may each be provided to one or both of training data database 134 and image database 132 to be stored. In some embodiments, feature vectors 332 and 334 may each be stored with their corresponding object identifier. For example, first feature vector 332, describing visual features extracted from first image 314, may be stored in image database 132 with first object identifier 316 (e.g., ID: Drill_0), while second feature vector 334, describing visual features extracted from second image 324, may be stored in image database 132 with second object identifier 326 (e.g., ID: Ball_1). In some embodiments, in addition to storing the feature vectors and object identifiers for each image, the image may also be stored in image database 132, as well as, or alternatively, training data database 134. For example, first image 314, first object identifier 316, and first feature vector 332 may be stored together in image database 132.

In some embodiments, the images, the feature vectors describing those images, or both, may be used to generate training data for training a computer-vision object recognition model. Therefore, when a new image is obtained, the computer-vision object recognition model may analyze the image, extract features from the image, and determine whether the image is similar to any other image from the training data set. For example, if a new image depicting a new drill is received, the computer-vision object recognition model may generate a feature vector for the new image and compare the feature vector to feature vector 332 (e.g., describing image 314. depicting a drill). If a distance between the two feature vectors (e.g., a cosine distance, Minkowski distance, Euclidean distance, etc.) is less than a threshold value, then this may indicate that the two images are similar, and therefore they both may depict the same object (e.g., a drill). In some embodiments, the object identifier associated with the “matched” image, for example first object identifier 316 of image 314, may be assigned to the new image, and the feature vector obtained from the new image, the new image, or both the feature vector obtained from the new image and the new image, may be stored in image database 132, as well as, or alternatively, training data database 134 with the object identifier (e.g., first object identifier 316). Thus, the initial training data set, which only included a single image depicting a drill (e.g., image 314), may now include two images depicting a drill. Therefore, upon retraining the computer-vision object recognition model, parameters of the model may be enriched such that the parameters encode additional information describing some of the visual features from the new image in addition to the information describing the visual features of the previously analyzed image.

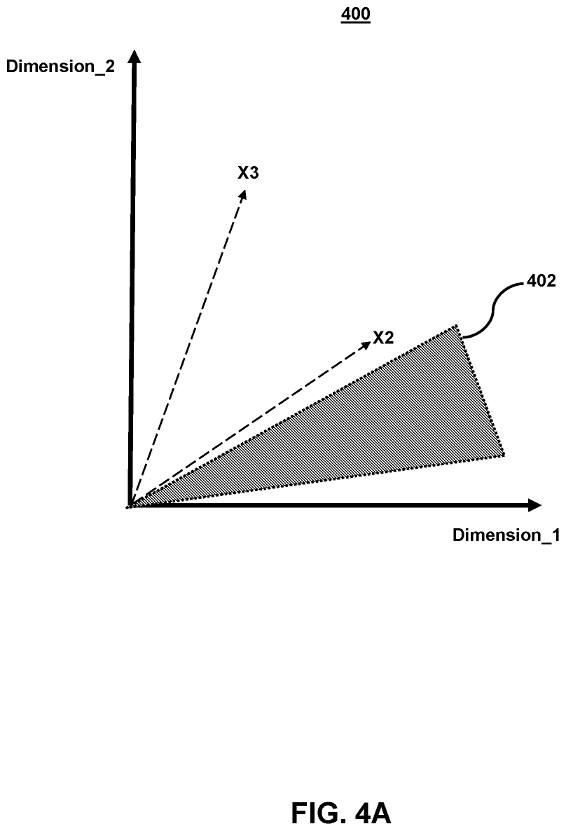

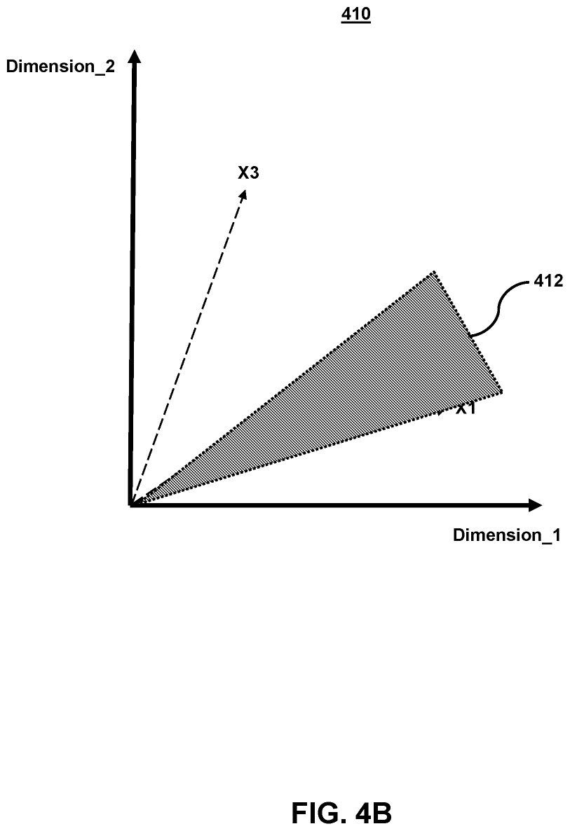

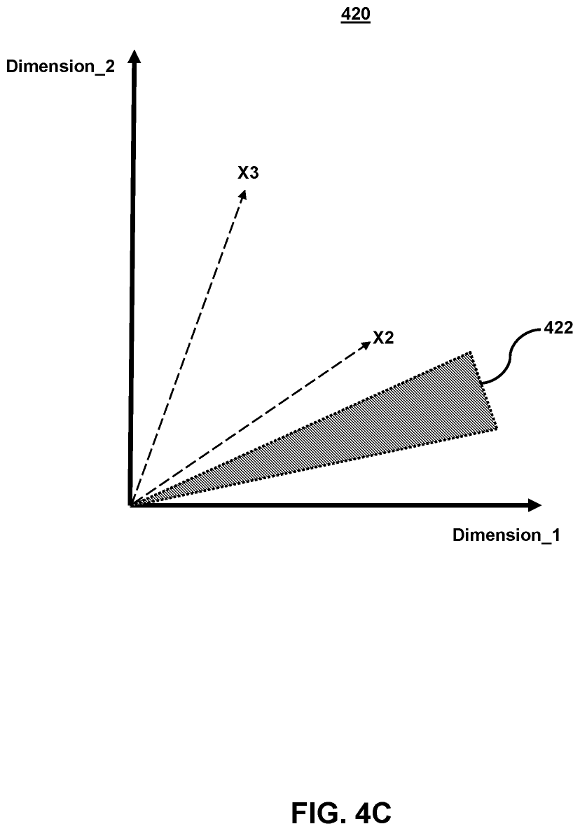

FIGS. 4A-4C illustrate example graphs of feature vectors representing features extracted from images and determining a similarity between the feature vectors and a feature vector corresponding to a newly received image, in accordance with various embodiments. In some embodiments, a graph 400 of FIG. 4A illustrates a first feature vector x₁, a second feature vector x₂, and a third feature vector x₃. Each of feature vectors x₁, x₂, and x₃ may represent visual features extracted from images depicting objects. In some embodiments, feature vectors x₁, x₂, and x₃ may represent feature vectors output by a computer-vision object recognition model, such as computer-vision object recognition model 310, which may obtain a training data set including images depicting objects.

As illustrated in graph 400, for example, each of feature vectors x₁, x₂, and x₃ point to a different location within a two-dimensional feature space. Use of a two-dimensional feature space in the example is merely for illustrative purpose as each feature vector may be n-dimensional. In some embodiments, feature vectors that are closer together (e.g., determined based on a cosine distance between the vectors) may describe features that are similar, and thus the images with which those features were extracted from may be similar. Conversely, feature vectors that are further from each other in the feature space may describe features that are not similar, and thus the images with which those features were extracted from may not be similar. As an example, feature vector x₁ and feature vector x₂ are closer together than feature vector x₁ and feature vector x₃ (e.g., based on the dot-product of vectors x₁ and x₂ as compared to the dot-product of vectors x₁ and x₃). Therefore, the images corresponding to feature vectors x₁ and x₂ are more likely to be similar (e.g., depict a similar object) than the images corresponding to feature vectors x₁ and x₃.

In some embodiments, when a new image is obtained by computer system 102 and analyzed using a computer-vision object recognition model trained on the image that produced feature vectors x₁, x₂, and x₃, a determination may be made as to whether the new image is similar to any of the other images from the training data set. For example, a new image provided to the trained computer-vision object recognition model may yield feature vector Y. As seen from graph 400, feature vector Y is near feature vector x₁. In some embodiments, a similarity between feature vector Y and feature vector x₁ may be determined (as well as a similarity between feature vector Y and the other feature vectors included within graph 400. For example, a cosine distance between feature vector Y and feature vector x₁ may be computed. If the cosine distance is less than a threshold value, then the image described by feature vector Y may be classified as being similar to the image described by feature vector x₁. Therefore, the image described by feature vector Y, feature vector Y, or both, may be stored in memory in association with an object identifier of an object depicted by an image described by feature vector x₁.

In some embodiments, a region 402 illustrated in graph 400 may represent a portion of the two-dimensional feature space that may correspond to images classified as being similar to the image associated with feature vector x₁. For instance, region 402 may subtend a solid angle such that any feature vector falling within region 402 would have a dot product with feature vector x₁ that is less than a threshold distance value, indicating that the two images (e.g., the images associated with the two vectors) depict similar objects. Thus, in some embodiments, if a feature vector, such as feature vector Y, falls within region 402, that vector may be assigned a same object identifier that the object of the image described by feature vector x₁ is labeled with. Conversely, any feature vector that does not fall within region 402 may not be assigned the object identifier that the object of the image described by feature vector x₁ is labeled with, indicating that those two images depict dissimilar objects (e.g., the images associated with feature vectors x₂ and x₃).

In some embodiments, upon assigning the object identifier associated with an image from the training data set to a new image, the new image's feature vector, or both, a determination may be made as to whether the new image's feature vector is similar to any other feature vector. For instance, although prior to adding the new feature vector to the two-dimensional feature space, two feature vectors may have been classified as being dissimilar. For example, feature vectors x₁ and x₂ may have initially been classified as being dissimilar (e.g., feature vector x₂ falls outside of region 402). However, as seen in graph 410 of FIG. 4B, feature vector Y may be determined to be similar to feature vector x₂, as feature vector x₂ may fall within a region 412. Similar to region 402 described above, region 412 may also subtend a solid angle such that any feature vector falling within region 412 would have a dot product with feature vector Y that is less than a threshold distance value, indicating that the two images (e.g., the images associated with the two vectors) depict similar objects. Therefore, the image described by feature vector x₂ may be classified as being similar to the image described by feature vector Y, and thus the object identifier assigned to feature vector Y may be assigned to feature vector x₂, the image described by feature vector x₂, or both. Thus, even though initially the object recognition model classified the images described by feature vectors x₁ and x₂ as not being similar, the addition of feature vector Y is able to recapture feature vector x₂ and identify the corresponding image as being similar.

In some embodiments, the aforementioned process may be repeated until one or more stopping criteria are met. For instance, after determining that the images depicted by feature vector x₂ and feature vector Y are similar (e.g., based on a cosine distance between feature vector x₂ and feature vector Y being less than a first threshold distance corresponding to the angle subtended by region 412), a determination may be made if there are any other feature vectors that may now be classified as being similar to feature vector x₂. If so, then those feature vectors may be assigned the object identifier recently attributed to feature vector x₂. As mentioned above, this process may repeat, iteratively, as new feature vectors are identified. However, in some embodiments, this process may cease upon one or more stopping criteria being met. In some embodiments, the stopping criteria may include a certain number of iterations being performed (e.g., 5 iterations, 10 iterations, etc.), allowing the process to repeat for a certain amount of time (e.g., 1 second, 2 seconds, 5 seconds, etc.), or until now more feature vectors are determined to be within the first threshold distance of the feature vector.

In some embodiments, each of the feature vectors that are determined to be similar to another feature vector may be added to a training data set used to train the object recognition model, a new instance of the object recognition model, or both. Therefore, while the initial training data set may have only included a single image depicting a given object (e.g., a drill), after the iterations are performed, multiple images may now be added to the training data set, where each of the images depict a same or similar object that each depict a drill or an object similar to the drill. For example, if the image associated with feature vector x₁ depicted a drill from a first perspective (e.g., first image 314), the image associated with feature vector Y may depict another drill of a different make or model, but having the same perspective. The training data set may then be updated to include the image associated with feature vector Y, feature vector Y, or both, and so now the training data set may include two images. Continuing this example, the image associated with feature vector x₂ may depict the same drill as the drill depicted by the new image associated with feature vector Y, however at a different perspective (e.g., 180-degrees relative to a coordinate system of the drill within first image 314). Therefore, by identifying that the images associated with feature vectors x₁ and Y both depict a same type of object (e.g., a drill) from a same perspective, this allowed the system to identify that the object depicted within the image associated with feature vector x₂ is also similar. Thus, the training data set may now be updated to include three images, each depicting a same class of objects (e.g., drills) but with different features. When the object recognition model, a new instance of the object recognition model, or a new object recognition model is subsequently trained using the new training data, the parameters of the object recognition model will be enriched so that the newly trained object recognition model will have improved accuracy at recognizing whether an image depicts of that object.

In some embodiments, even if an image is determined to be similar to another image, that image may not be added to a training data set. For example, if a newly received image depicting an object is a replica of another image already included by the training data set, the new image may not be added to the training data set despite the object recognition model classifying the two images as being similar.

Some embodiments may include determining whether an image is too similar to another image (e.g., imparts insufficient entropy relative to members of the set corresponding to an object, for instance measured in terms of volume of a convex hull with and without the candidate) and, if so, preventing that image from being added to the training data set. For example, if a distance between two feature vectors describing features extracted two different images, one being a newly received image and one being an image from the training data set, is determined to be smaller than a second distance threshold, then the new image and its feature vector may not be added to the training data set, despite the new image being classified as similar to the other image. As seen in graph 420 of FIG. 4C, a region 422 may subtend an angle about feature vector x₁ such that a feature vector Y associated with a newly received image falls within region 422, this may indicate that the dot product between those two feature vectors is approximately one (e.g., Cos(θ)˜1). Therefore, in some embodiments, a determination may be made as to whether the distance between the feature vectors is less than or equal to a second threshold, indicating that the two feature vectors describe images that are too similar, or alternatively, whether distance is greater than or equal to the second threshold, indicating that the two feature vectors describe images that are not too similar. As an example, a distance between feature vector Y and feature vector x₁ of FIG. 4C may be less than a second threshold (e.g., Cos(θ)≥0.99, Cos(θ)≥0.95, etc.) indicating that the image associated with feature vector Y should not be added to the training data set in association with the object identifier of the image associated with feature vector x₁. Alternatively, the distance between feature vector Y and feature vector x₁ of FIG. 4B may be greater than or equal to a second threshold, depicted by region 422, which may indicate that the image associated with feature vector Y (i) is similar to the image associated with feature vector x₁ (e.g., the distance is less than or equal to a first threshold distance), and (ii) is not identical to the image associated with feature vector x₁.

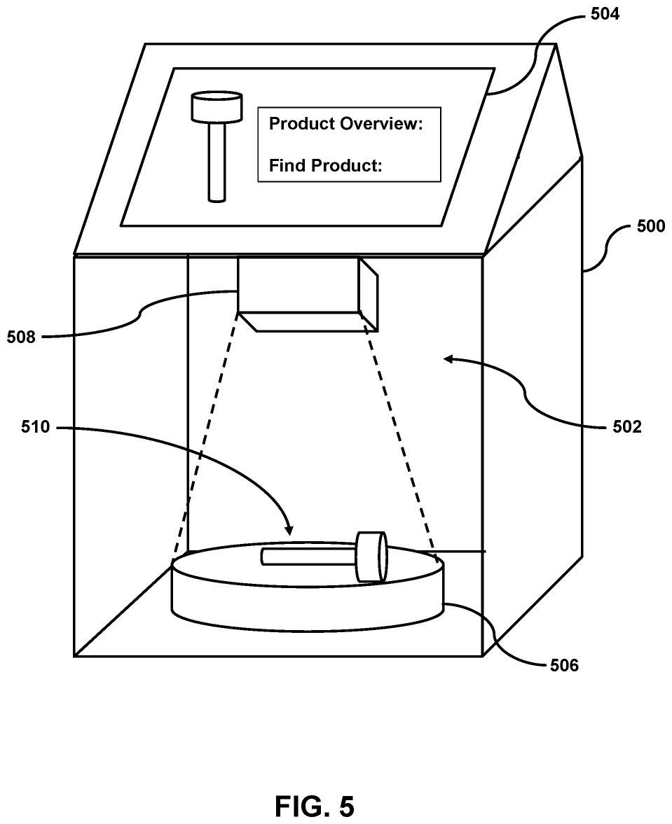

FIG. 5 illustrates an example kiosk device for capturing images of objects and performing visual searches for those objects, in accordance with various embodiments. In some embodiments, kiosk device 500 may be a device configured to receive an object, capture an image of the object, facilitate performance of a visual search using the image of the object as an input query image, and provide information regarding one or more results of the visual search. Kiosk device 500 of FIG. 5 may be substantially similar to kiosk 106 of FIG. 1, and the previous descriptions may apply equally.

Kiosk device 500 may include an open cavity 502 where objects may be placed. For example, cavity 502 may be surrounded on five sides by walls or other physical structures, which may be impermissible to light, semi-transparent, or fully transparent, while one side may be open such that individuals may place objects within cavity 502. In some embodiments, individuals may place objects within cavity 502 to obtain information about the object. For example, if an individual needs to identify a type of fastener, the individual may bring the fastener to a facility where kiosk device 500 is located, place the fastener within cavity 502, and obtain information regarding the type of fastener, sub-type of fastener, color, shape, size, weight, material composition, location of that fastener within the facility, a cost for purchasing the fastener, or any other information related to the fastener, or any combination thereof. In some embodiments, kiosk device 500 may include one or more sensors capable of determining information about the object placed within cavity 502. For example, kiosk device 500 may include a weight sensor 506, which may be configured to determine a weight of an object 510 placed within cavity 502. As another example, kiosk device 500 may include sensors capable of determining a density of object 510, length, width, depth, height, etc., of object 510, density of object 510, a material composition of object 510, or any other feature or characteristic of object 510, or any combination thereof in some embodiments, sensors 506 may be located on an inner surface of cavity 502 of kiosk device 500. In some embodiments, one or more of sensors 506 may be integrated within a lower wall of cavity 502 (e.g., a bottom wall), any of the side walls, the upper wall, or a combination thereof. In some embodiments, kiosk device 500 may include one or more processors and memory storing computer program instructions that, when executed by the processors, cause sensors 506 to record data representative of a measurement captured by sensors 506. For example, sensors 506 may continually, periodically, or upon request (e.g., in response to a user pressing a button or determining that an object has entered into the space of cavity 502) capture a weight detected by sensors 506. In some embodiments, the data (e.g., weight data) may be stored in memory of kiosk device 500 and used as an input channel for a visual search.

In some embodiments, kiosk device 500 may include one or more image capture components 608 configured to capture an image of an object (e.g., object 510) placed within cavity 502. For example, image capture components 508 may include one or more cameras configured to capture two-dimensional images, three-dimensional images, high definition images, videos, time series images, image bursts, and the like. In some embodiments, image capture components 508 may have a field of view (FOV) capable of capturing an image or video of some or all of a surface of sensors 506. In some embodiments, image capture components 508 may include one or more infrared scanning devices capable of scanning cavity 502 to determine a shape of object 510, textures, patterns, or other properties of object 510, or additional features of object 510. In some embodiments, image capture components 508 may generate, store, and output data representative of the image, video, scan, etc., captured thereby, which may be stored in memory of kiosk device 500.

Kiosk device 500 may also include a display screen 504 located on an upper surface of kiosk device 500. Alternatively, display screen 504 may be a separate entity coupled to kiosk device 500 (e.g., a separate display screen). In some embodiments, display screen 504 may display an interface viewable by an individual, such as the individual that placed object 510 within cavity 502. Display screen 504 may provide a real-time view of object 510 from various perspectives, such as a perspective of image capture components 508. In some embodiments, display screen 504 may display a captured image or video of object 510 after being captured by image capture components 508. For instance, after capturing an image of object 510, an image of object 510 may be displayed to an individual via display screen.

Some embodiments may include providing the image of the object (e.g., object 510), as well as any additional information about the object determined by sensors 506, image capture components 508, or both, to a computer system capable of performing a visual search. For instance, the image and any other data regarding object 510 determined by kiosk device 500 may be provided to a computer system, such as computer system 102 of FIG. 1, to perform a visual search. In some embodiments, a computer system including visual search functionality may be located at a same facility as kiosk device 500. In some embodiments, kiosk device 500 may include the visual search functionality, and may therefore perform the visual search itself. Upon providing the image depicting object 510, and any other information (e.g., weight of object 510), to the visual search system, search results indicating objects determined as being similar to object 510 may be displayed via display screen 504. For example, the image depicting object 510, as well as the additional information, if available, may be provided to computer system 102. Computer system 102 may extract visual features describing object 510 using a trained computer-recognition object recognition model, and may generate a feature vector describing at least a subset of the extracted visual features. The feature vector may be mapped to an n-dimensional feature space, and distances between the feature vector and other feature vectors (each corresponding to a set of visual features extracted from an image previously analyzed by the computer-vision object recognition model) may be computed. If the distance between the feature vector describing the visual features extracted from the image depicting object 510 and a feature vector describing visual features extracted from an image depicting an object is determined to be less than a threshold distance value, then the image depicting object 510 and the image depicting the object may be classified as being similar to one another. Therefore, an object identifier used to label the object depicted by the previously analyzed image may be assigned to the image depicting object 510. In some embodiments, the object identifier, the image depicting object 510, and the feature vector describing the image depicting object 510 may be stored in memory (e.g., image database 132) together. Furthermore, information previously obtained describing the other image may be presented to an individual (e.g., the individual that placed object 510 within cavity 502) via display screen 504. For example, if object 510 is a particular fastener that an individual seeks to purchase additional instances of, the results of the search performed using the image of the fastener may indicate the name of the fastener, a brand of the fastener, a type of the fastener, a cost of the fastener, a material composition of the fastener, and a location of where the fastener is located within a facility so that the individual may obtain additional instances of the fastener. In some embodiments, an individual may be capable of purchasing instances of the identified object via kiosk device 500, such as by inputting payment information and delivery information such that the additional instances of the identified object may be shipped directly to the individual's home. In some embodiments, kiosk device 500 may be in communication with a three-dimensional printing device, and in response to identifying the object, kiosk device 500 may facilitate the three-dimensional printing device to print a replica of the identified object.

FIG. 6 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000. In some embodiments, computer system 102, mobile computing device 104, and kiosk 106 may include some or all of the components and features of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein,

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality' of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

A1. A tangible, non-transitory, computer-readable medium storing computer program instructions that when executed by one or more processors effectuate operations comprising: obtaining, with a computer system, a first training set to train a computer vision model, the first training set comprising images depicting objects and labels corresponding to object identifiers and indicating which object is depicted in respective labeled images; training, with the computer system, the computer vision model to detect the objects in other images based on the first training set, wherein the training the computer vision model comprises: encoding depictions of objects in the first training set as vectors in a vector space of lower dimensionality than at least some images in the first training set, and designating, based on the vectors, locations in the vector space as corresponding to object identifiers; detecting, with the computer system, a first object in a first query image by obtaining a first vector encoding a first depiction of the first object and selecting a first object identifier based on a first distance between the first vector and a first location in the vector space designated as corresponding to the first object identifier by the trained computer vision model; determining, with the computer system, based on the first distance between the first vector and the first location in the vector space, to include the first image or data based thereon in a second training set; and training, with the computer system, the computer vision model with the second training set
A2. The tangible, non-transitory, computer-readable medium of embodiment A1, wherein determining to include the first image or data based thereon in the second training set comprises: determining that the first image depicts the first object with more than a threshold level of confidence; an determining that the first vector imparts more than a threshold amount of entropy to a set of vectors encoding depictions of the first object in the vector space.
A3. The tangible, non-transitory, computer-readable medium of embodiment A1, wherein determining to include the first image or data based thereon in the second training set comprises: determining, with a plurality of other offline computer vision models, scores indicating whether the first object is depicted in the first query image; and combining the plurality of scores in the output of an ensemble model; and determining to include the first image or data based thereon in the second training set based on the output of an ensemble model indicating a higher confidence that the first object is depicted in the first query image than the first distance between the first vector and the first location in the vector space designated as corresponding to the first object identifier.
A4. The tangible, non-transitory, computer-readable medium of any one of embodiments A1-A3, wherein: the obtained training set depicts objects in an ontology of objects including more than 100 different objects; the computer vision model is configured to return search results within less than 500 milliseconds of receiving query images; the obtained training set has fewer than 10 images for each of at least some of the objects depicted; and the operations comprise, before training the computer vision model with the second training set: detecting, with the computer system, a second object in a second query image by obtaining a second vector encoding a second depiction of the second object and selecting a second object identifier based on a second distance between the second vector and a second location in the vector space designated as corresponding to the second object identifier by the trained computer vision model; and determining, with the computer system, based on the second distance between the second vector and the second location in the vector space, to not include the second image or data based thereon in the second training set.
B1. A method comprising: obtaining, with a computer system, a training data set comprising: a first image depicting a first object labeled with a first identifier of the first object, and a second image depicting a second object labeled with a second identifier of the second object; causing, with the computer system, based on the training data set, a computer-vision object recognition model to be trained to detect the first object and the second object to obtain a trained computer-vision object recognition model, wherein: parameters of the trained computer-vision object recognition model encode first information about a first subset of visual features of the first object, and the first subset of visual features of the first object is determined based on one or more visual features extracted from the first image; obtaining, with the computer system, after training and deployment of the trained computer-vision object recognition model, a third image; and determining, with the computer system, with the trained computer-vision object recognition model, that the third image depicts the first object and, in response: causing the first identifier or a value corresponding to the first identifier to be stored in memory in association with the third image, one or more visual features extracted from the third image, or the third image and the one or more visual features extracted from the third image, determining, based on a similarity of the one or more visual features extracted from the first image and the one or more visual features extracted from the third image, that the third image is to be added to the training data set for retraining the trained computer-vision object recognition model, and enriching the parameters of the trained computer-vision object recognition model to encode second information about a second subset of visual features of the first object based on the one or more visual features extracted from the third image, wherein the second subset of visual features of the first object differs from the first subset of visual features of the first object.
B2. The method of embodiment B1, further comprising: determining, with the computer system, the similarity between the one or more visual features extracted from the first image and the one or more visual features extracted from the third image, wherein the similarity is determined by: computing a distance between the one or more visual features extracted from the first image and the one or more visual features extracted from the third image.
B3. The method of embodiment B2, wherein the distance comprises at least one of a cosine distance, a Minkowski distance, or a Euclidean distance.
B4. The method of any one of embodiments B2-B3, wherein the parameters of the trained computer-vision object recognition model are enriched in response to: determining, with the computer system, that the distance between the one or more visual features extracted from the first image and the one or more visual features extracted from the third image is less than a predetermined threshold distance.
B5. The method of any one of embodiments B2-B4, wherein determining that the third image is to be added to the training data set for retraining the trained computer-vision object recognition model comprises: determining that the distance between the one or more visual features extracted from the first image and the one or more visual features extracted from the third image is less than a first threshold distance and greater than a second threshold distance, wherein: the first threshold distance indicates whether the third image depicts the object, and the second threshold distance indicates whether the object, as depicted in the third image, is represented differently than the object as depicted in the first image.
B6. The method of any one of embodiments B1-B5, further comprising: determining, with the computer system, a distance between the one or more visual features extracted from the third image and one or more visual features extracted from a fourth image, wherein: the trained computer-vision object recognition model previously determined that the object was absent from the fourth image; causing, with the computer system, in response to determining that the distance between the one or more visual features extracted from the third image and the one or more visual features extracted from the fourth image is less than the predefined threshold distance, the first identifier or the value corresponding to the first identifier to be stored in the memory in association with the fourth image, the one or more visual features extracted from the fourth image, or the fourth image and the one or more visual features extracted from the fourth image; and enriching, with the computer system, the parameters of the trained computer-vision object recognition model to encode third information about a third subset of visual features of the first object based on the one or more visual features extracted from the fourth image, wherein: the third subset of visual features of the first object differs from the first subset of visual features of the first object and the second subset of visual features of the first object.
B7. The method of any one of embodiments B1-B6, further comprising: obtaining, with the computer system, for each of a plurality of images, one or more visual features extracted from a corresponding image of the plurality of images, wherein: the trained computer-vision object recognition model previously determined that the object was not depicted by each of the plurality of images; determining, with the computer system, a similarity between each of the plurality of images and the third image; determining, with the computer system, based on the similarity between each of the plurality of images and the third image, a set of images from the plurality of images that depict the object; and causing, with the computer system, the first identifier or the value corresponding to the first identifier to be stored in the memory in association with each image from the set of images from the plurality of images, one or more visual features extracted from each image of the set of images, or the set of images, or each image from the set of images from the plurality of images and the one or more visual features extracted from each image of the set of images, or the set of images.
B8. The method of embodiment B7, further comprising: performing, with the computer system, the following iteratively until at least one stopping criterion is met: determining a similarity between each image from the set of images and remaining images from the plurality of images, wherein the remaining images from the plurality of images exclude the set of images; determining whether the similarity between an image of the set of images and an image from the remaining images from the plurality of images indicates that the object is depicted within one or more images from the remaining images from the plurality of images; and causing the first identifier or the value corresponding to the first identifier to be stored in memory in association with each of the one or more images, one or more visual features extracted from each of the one or more images, or the one or more images and the one or more visual features extracted from each of the one or more images.
B9. The method of embodiment B8, wherein the at least one stopping criterion comprises at least one of: a threshold number of iterations having been performed, an amount of time with which the plurality of images have been stored, or an amount of time since the trained computer-vision object recognition model was trained exceeding a threshold amount of time.
B10. The method of any one of embodiments B1-139, further comprising: determining, with the computer system, a distance between the one or more visual features extracted from the third image and one or more visual features extracted from a fourth image, wherein: the trained computer-vision object recognition model previously determined that the object was absent from the fourth image; determining, with the computer system, that the distance is greater than a predefined threshold distance; and preventing the first identifier or the value corresponding to the first identifier from being stored in the memory in association with the fourth image and the one or more visual features extracted from the fourth image.
B11. The method of any one of embodiments B1-B10, further comprising: determining the similarity of the one or more visual features extracted from the first image and the one or more visual features extracted from the third image by: computing a distance between the one or more visual features extracted from the first image and the one or more visual features extracted from the third image; and causing, with the computer system, in response to determining that the distance is less than a predefined threshold distance, the trained computer-vision object recognition model to be retrained based on the first image, the second image, and the third image.
B12. The method of any one of embodiments B1-B11, wherein: the trained computer-vision object recognition model comprises a deep neural network comprising six or more layers; and the parameters of the trained computer-vision object recognition model comprise weights and biases of layer of the deep neural network.
B13. The method of any one of embodiments B1-B12, further comprising: determining, with the computer system, a distance between the one or more visual features extracted from the third image and one or more visual features extracted from a fourth image, wherein the trained computer-vision object recognition model previously determined that the object was absent from the fourth image; determining, with the computer system, that the distance is less than a first predefined threshold distance; determining, with the computer system, that the distance is less than a second predefined threshold distance; and preventing the first identifier or the value corresponding to the first identifier from being stored in the memory in association with the fourth image and the one or more visual features extracted from the fourth image.
B14. The method of embodiment B13, wherein: the distance being less than the first predefined threshold distance indicates that the fourth image depicts the object; and the distance being less than the second predefined threshold distance indicates that at least one of the first subset of visual features of the first object or the second subset of visual features of the first object is the same as a third subset of visual features of the first object generated based on one or more visual features extracted from the fourth image.
B15. The method of any one of embodiments B1-B14, wherein determining that the third image depicts the first object comprises: determining, with the computer system, using the trained computer-vision object recognition model, a first distance indicating how similar the first object is to an object depicted by the third image and a second distance indicating how similar the second object is to the object depicted by the third image; determining that the first distance is less than the second distance indicating that the object depicted by the third image has a greater similarity to the first object than to the second object; and determining that the first distance is less than a predefined distance threshold.
C. A tangible, non-transitory, machine-readable medium storing instructions that when executed by a data processing apparatus cause the data processing apparatus to perform operations comprising: the operations of any one of embodiments A1-A4 or B1-B15.
D1. A system, comprising: one or more processors; and memory storing instructions that when executed by the processors cause the processors to effectuate operations comprising: the operations of any one of embodiments A1-A4 or B1-B15.

What is claimed is:

1. A tangible, non-transitory, computer-readable medium storing computer program instructions that when executed by one or more processors effectuate operations comprising:
obtaining, with a computer system, a first training set to train a computer vision model, the first training set comprising images depicting objects and labels corresponding to object identifiers and indicating which object is depicted in respective labeled images;
training, with the computer system, the computer vision model to detect the objects in other images based on the first training set, wherein training the computer vision model comprises:
encoding depictions of objects in the first training set as vectors in a vector space of lower dimensionality than at least some images in the first training set, and
designating, based on the vectors, locations in the vector space as corresponding to object identifiers;
detecting, with the computer system, a first object in a first query image by obtaining a first vector encoding a first depiction of the first object and selecting a first object identifier based on a first distance between the first vector and a first location in the vector space designated as corresponding to the first object identifier by the trained computer vision model;
determining, with the computer system, based on the first distance between the first vector and the first location in the vector space, to include the first image or data based thereon in a second training set; and
training, with the computer system, the computer vision model with the second training set.

2. The tangible, non-transitory, computer-readable medium of claim 1, wherein determining to include the first image or data based thereon in the second training set comprises:
determining that the first image depicts the first object with more than a threshold level of confidence; and
determining that the first vector imparts more than a threshold amount of entropy to a set of vectors encoding depictions of the first object in the vector space.

3. The tangible, non-transitory, computer-readable medium of claim 1, wherein determining to include the first image or data based thereon in the second training set comprises:
determining, with a plurality of other offline computer vision models, scores indicating whether the first object is depicted in the first query image; and
combining the plurality of scores in the output of an ensemble model; and
determining to include the first image or data based thereon in the second training set based on the output of an ensemble model indicating a higher confidence that the first object is depicted in the first query image than the first distance between the first vector and the first location in the vector space designated as corresponding to the first object identifier.

4. The tangible, non-transitory, computer-readable medium of claim 1, wherein:
the obtained training set depicts objects in an ontology of objects including more than 100 different objects;
the computer vision model is configured to return search results within less than 500 milliseconds of receiving query images;
the obtained training set has fewer than 10 images for each of at least some of the objects depicted;
the vector space has more than 10 dimensions; and
the operations comprise, before training the computer vision model with the second training set:
detecting, with the computer system, a second object in a second query image by obtaining a second vector encoding a second depiction of the second object and selecting a second object identifier based on a second distance between the second vector and a second location in the vector space designated as corresponding to the second object identifier by the trained computer vision model; and
determining, with the computer system, based on the second distance between the second vector and the second location in the vector space, to not include the second image or data based thereon in the second training set.

5. A tangible, non-transitory, computer-readable medium storing computer program instructions that when executed by one or more processors effectuate operations comprising:
obtaining, with a computer system, a training data set comprising:
a first image depicting a first object labeled with a first identifier of the first object, and
a second image depicting a second object labeled with a second identifier of the second object;
causing, with the computer system, based on the training data set, a computer-vision object recognition model to be trained to detect the first object and the second object to obtain a trained computer-vision object recognition model, wherein:
parameters of the trained computer-vision object recognition model encode first information about a first subset of visual features of the first object, and
the first subset of visual features of the first object is determined based on one or more visual features extracted from the first image;
obtaining, with the computer system, after training and deployment of the trained computer-vision object recognition model, a third image; and
determining, with the computer system, with the trained computer-vision object recognition model, that the third image depicts the first object and, in response:
causing the first identifier or a value corresponding to the first identifier o be stored in memory in association with the third image, one or more visual features extracted from the third image, or the third image and the one or more visual features extracted from the third image,
determining, based on a similarity of the one or more visual features extracted from the first image and the one or more visual features extracted from the third image, that the third image is to be added to the training data set for retraining the trained computer-vision object recognition model, and
enriching the parameters of the trained computer-vision object recognition model to encode second information about a second subset of visual features of the first object based on the one or more visual features extracted from the third image, wherein the second subset of visual features of the first object differs from the first subset of visual features of the first object.

6. The tangible, non-transitory, computer-readable medium of claim 5, wherein the operations further comprise:
determining, with the computer system, the similarity of the one or more visual features extracted from the first image and the one or more visual features extracted from the third image, wherein the similarity is determined by:
computing a distance between the one or more visual features extracted from the first image and the one or more visual features extracted from the third image, wherein the distance comprises at least one of: a cosine distance, a Minkowski distance, a Mahalanobis distance, a Manhattan distance, or a Euclidean distance.

7. The tangible, non-transitory, computer-readable medium of claim 6, wherein the parameters of the trained computer-vision object recognition model are enriched in response to:
determining, with the computer system, that the distance between the one or more visual features extracted from the first image and the one or more visual features extracted from the third image is less than a predetermined threshold distance.

8. The tangible, non-transitory, computer-readable medium of claim 6, wherein determining that the third image is to be added to the training data set for retraining the trained computer-vision object recognition model comprises:
determining that the distance between the one or more visual features extracted from the first image and the one or more visual features extracted from the third image is less than a first threshold distance and greater than a second threshold distance, wherein:
the first threshold distance indicates whether the third image depicts the object, and
the second threshold distance indicates whether the object, as depicted in the third image, is represented differently than the object as depicted in the first image.

9. The tangible, non-transitory, computer-readable medium of claim 5, wherein the third image is obtained using a kiosk device and the first object comprises a product, the operation further comprise:
retrieving, with the computer system, product information describing of the product in response to determining that the third image depicts the first object;
generating, with the computer system, a user interface (UI) for display on a display screen of the kiosk device, wherein the UI is configured to display at least some of the product information; and
providing, with the computer system, the UI to the kiosk device for rendering.

10. The tangible, non-transitory, computer-readable medium of claim 5, wherein the operations further comprise:
determining, with the computer system, a distance between the one or more visual features extracted from the third image and one or more visual features extracted from a fourth image, wherein:
the trained computer-vision object recognition model previously determined that the object was absent from the fourth image;
causing, with the computer system, in response to determining that the distance between the one or more visual features extracted from the third image and the one or more visual features extracted from the fourth image is less than a predefined threshold distance, the first identifier or the value corresponding to the first identifier to be stored in the memory in association with the fourth image, the one or more visual features extracted from the fourth image, or the fourth image and the one or more visual features extracted from the fourth image; and
enriching, with the computer system, the parameters of the trained computer-vision object recognition model to encode third information about a third subset of visual features of the first object based on the one or more visual features extracted from the fourth image, wherein:
the third subset of visual features of the first object differs from the first subset of visual features of the first object and the second subset of visual features of the first object.

11. The tangible, non-transitory, computer-readable medium of claim 5, wherein the operations further comprise:
obtaining, with the computer system, for each of a plurality of images, one or more visual features extracted from a corresponding image of the plurality of images, wherein:
the trained computer-vision object recognition model previously determined that the object was not depicted by each of the plurality of images;
determining, with the computer system, a similarity between each of the plurality of images and the third image;
determining, with the computer system, based on the similarity between each of the plurality of images and the third image, a set of images from the plurality of images that depict the object; and
causing, with the computer system, the first identifier or the value corresponding to the first identifier to be stored in the memory in association with each image from the set of images from the plurality of images, one or more visual features extracted from each image of the set of images, or the set of images, or each image from the set of images from the plurality of images and the one or more visual features extracted from each image of the set of images, or the set of images.

12. The tangible, non-transitory, computer-readable medium of claim 11, wherein the operations further comprise:
performing, with the computer system, the following iteratively until at least one stopping criterion is met:
determining a similarity between each image from the set of images and remaining images from the plurality of images, wherein the remaining images from the plurality of images exclude the set of images;
determining whether the similarity between an image of the set of images and an image from the remaining images from the plurality of images indicates that the object is depicted within one or more images from the remaining images from the plurality of images; and
causing the first identifier or the value corresponding to the first identifier to be stored in memory in association with each of the one or more images, one or more visual features extracted from each of the one or more images, or the one or more images and the one or more visual features extracted from each of the one or more images.

13. The tangible, non-transitory, computer-readable medium of claim 12, wherein the at least one stopping criterion comprises at least one of: a threshold number of iterations having been performed, an amount of time with which the plurality of images have been stored, or an amount of time since the trained computer-vision object recognition model was trained exceeding a threshold amount of time.

14. The tangible, non-transitory, computer-readable medium of claim 5, wherein the operations further comprise:
determining, with the computer system, a distance between the one or more visual features extracted from the third image and one or more visual features extracted from a fourth image, wherein:
the trained computer-vision object recognition model previously determined that the object was absent from the fourth image;
determining, with the computer system, that the distance is greater than a predefined threshold distance; and
preventing the first identifier or the value corresponding to the first identifier from being stored in the memory in association with the fourth image and the one or more visual features extracted from the fourth image.

15. The tangible, non-transitory, computer-readable medium of claim 5, wherein the operations further comprise:
determining the similarity of the one or more visual features extracted from the first image and the one or more visual features extracted from the third image by: computing a distance between the one or more visual features extracted from the first image and the one or more visual features extracted from the third image; and
causing, with the computer system, in response to determining that the distance is less than a predefined threshold distance, the trained computer-vision object recognition model to be retrained based on the first image, the second image, and the third image.

16. The tangible, non-transitory, computer-readable medium of claim 5, wherein:
the trained computer-vision object recognition model comprises a deep neural network comprising six or more layers; and
the parameters of the trained computer-vision object recognition model comprise weights and biases of layer of the deep neural network.

17. The tangible, non-transitory, computer-readable medium of claim 5, wherein the operations further comprise:
determining, with the computer system, a distance between the one or more visual features extracted from the third image and one or more visual features extracted from a fourth image, wherein:
the trained computer-vision object recognition model previously determined that the object was absent from the fourth image;
determining, with the computer system, that the distance is less than a first predefined threshold distance;
determining, with the computer system, that the distance is less than a second predefined threshold distance; and
preventing the first identifier or the value corresponding to the first identifier from being stored in the memory in association with the fourth image and the one or more visual features extracted from the fourth image.

18. The tangible, non-transitory, computer-readable medium of claim 17, wherein:
the distance being less than the first predefined threshold distance indicates that the fourth image depicts the object; and
the distance being less than the second predefined threshold distance indicates that at least one of the first subset of visual features of the first object or the second subset of visual features of the first object is the same as a third subset of visual features of the first object generated based on one or more visual features extracted from the fourth image.

19. The tangible, non-transitory, computer-readable medium of claim 5, wherein determining that the third image depicts the first object comprises:
determining, with the computer system, using the trained computer-vision object recognition model, a first distance indicating how similar the first object is to an object depicted by the third image and a second distance indicating how similar the second object is to the object depicted by the third image;
determining that the first distance is less than the second distance indicating that the object depicted by the third image has a greater similarity to the first object than to the second object; and
determining that the first distance is less than a predefined distance threshold.

20. A method, comprising:
obtaining, with a computer system, a training data set comprising:
a first image depicting a first object labeled with a first identifier of the first object, and
a second image depicting a second object labeled with a second identifier of the second object;
causing, with the computer system, based on the training data set, a computer-vision object recognition model to be trained to detect the first object and the second object to obtain a trained computer-vision object recognition model, wherein:
parameters of the trained computer-vision object recognition model encode first information about a first subset of visual features of the first object, and
the first subset of visual features of the first object is determined based on one or more visual features extracted from the first image;
obtaining, with the computer system, after training and deployment of the trained computer-vision object recognition model, a third image; and
determining, with the computer system, with the trained computer-vision object recognition model, that the third image depicts the first object and, in response:
causing the first identifier or a value corresponding to the first identifier to be stored in memory in association with the third image, one or more visual features extracted from the third image, or the third image and the one or more visual features extracted from the third image,
determining, based on a similarity of the one or more visual features extracted from the first image and the one or more visual features extracted from the third image, that the third image is to be added to the training data set for retraining the trained computer-vision object recognition model, and
enriching the parameters of the trained computer-vision object recognition model to encode second information about a second subset of visual features of the first object based on the one or more visual features extracted from the third image, wherein the second subset of visual features of the first object differs from the first subset of visual features of the first object.
